(19) United States
(12) Patent Application Publication
(10) Pub. No.: US 2021/0260989 A1
(43) Pub. Date: Aug. 26, 2021

(54) HYDROGEN FUELING SYSTEM

(71) Applicant: 3M INNOVATIVE PROPERTIES COMPANY, St. Paul, MN (US)

(72) Inventors: Raymond P. Johnston, Lake Elmo, MN (US); Andrew J.L. Steinbach, Shorview, MN (US); Krzysztof A. Lewinski, Mahtomedi, MN (US); Fuxia Sun, Woodbury, MN (US); Andrew T. Haug, Woodbury, MN (US); John E. Abulu, Woodbury, MN (US); Sean M. Luopa, Minneapolis, MN (US); Jiyoung Park, Woodbury, MN (US); Attila Molnar, Vadnais Heights, MN (US); Cedric Bedoya, Woodbury, MN (US)

(21) Appl. No.: 17/274,670

(22) PCT Filed: Sep. 20, 2019
(86) PCT No.: PCT/IB2019/058000

§ 371 Date: Mar. 9, 2021

Related U.S. Application Data
(60) Provisional application No. 62/738,100, filed on Sep. 28, 2018.

(51) Int. Cl. B60K 15/03; C25B 1/04; C25B 9/23; C25B 11/055; C25B 11/081; F17C 5/06

(52) U.S. Cl. CPC B60K 15/03006; C25B 1/04; C25B 9/23; C25B 11/055; C25B 11/081; B60K 2015/03315; F17C 2221/012; F17C 2270/0184; F17C 2270/0139; B60K 2015/03019; F17C 5/06

(57) ABSTRACT

A hydrogen fueling system for generating hydrogen on demand is described. The system includes an electrolyzer configured to generate at least a predetermined quantity of hydrogen in a predetermined time when operated at no less than a predetermined current density and provided with at least a predetermined electrical energy over the predetermined time, where the predetermined quantity of hydrogen is at least 1 kg of hydrogen, the predetermined time is no more than 30 minutes, and the predetermined current density is at least 5 A/cm². The system may further include an electrical energy storage system electrically connected to the electrolyzer and capable of supplying at least 20% of the predetermined electrical energy over the predetermined time. The electrolyzer may include an anode including a plurality of acicular particles dispersed in an ionomer binder, where the acicular particles include iridium.

### BACKGROUND

Electrolyzers can be used to generate hydrogen in hydrogen fueling stations.

### SUMMARY

In some aspects of the present description, a hydrogen fueling system for generating hydrogen on demand is provided. The hydrogen fueling system includes an electrolyzer configured to generate at least a predetermined quantity of hydrogen in a predetermined time when operated at no less than a predetermined current density and provided with at least a predetermined electrical energy over the predetermined time, a vehicle tank filling system connected to the electrolyzer and configured to at least partially fill a tank of a vehicle with hydrogen generated by the electrolyzer, and an electrical energy storage system electrically connected to the electrolyzer. The predetermined quantity of hydrogen is at least 1 kg of hydrogen, the predetermined time is no more than 30 minutes, and the predetermined current density is at least 5 A/cm². The electrical energy storage system is capable of supplying at least 20% of the predetermined electrical energy over the predetermined time.

In some aspects of the present description, a hydrogen fueling system for generating hydrogen on demand is provided. The hydrogen fueling system includes an electrolyzer configured to generate hydrogen, and a vehicle tank filling system connected to the electrolyzer and configured to at least partially fill a tank of a vehicle with hydrogen generated by the electrolyzer. The electrolyzer includes a proton-exchange membrane having first and second opposed major surfaces, a cathode on the first major surface of the proton-exchange membrane, and an anode on the second major surface of the proton-exchange membrane. The anode includes (a) an ionomer binder, and (b) a plurality of acicular particles dispersed throughout the ionomer binder. The acicular particles include an elongated core with a layer of catalytic material on at least one portion of a surface of the elongated core. The catalytic material includes iridium. The elongated core includes at least one of a polynuclear aromatic hydrocarbon, heterocyclic compounds, or combinations thereof.

### BRIEF DESCRIPTION OF THE DRAWINGS

FIGS. 1A-1B are schematic illustrations of electrolyzers;

FIGS. 2A-2B are schematic illustrations of hydrogen fueling systems;

FIG. 3 is a schematic cross-sectional view of an acicular particle;

FIGS. 4-5 illustrate cell voltages versus current density for various anodes; and

FIG. 6 illustrates the current density at a cell voltage of 1.5 volts versus electrode loading for various electrolyzers.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

An electrolyzer is a device that can be used to produce hydrogen, carbon monoxide, or formic acid, etc. based on the input reactant (e.g., water or carbon dioxide). The present description is concerned primarily with hydrogen fueling systems that utilize an electrolyzer for generating hydrogen that can be used to at least partially fill a tank of a vehicle. An electrolyzer configured to generate hydrogen utilizes water as the input reactant. In some embodiments, at least one of the electrodes of the electrolyzer includes a nanostructured thin film (NSTF) catalyst layer as described in PCT Publ. No. WO 2016/191057 and U.S. application Ser. No. 15/575,454, for example. In some embodiments, compositions described herein containing acicular particles having a catalyst thereon are used in an anode of an electrolyzer to provide an increased rate of hydrogen production per unit of catalyst.

In some embodiments, electrolyzers described herein are configured to generate at least a predetermined quantity of hydrogen in a predetermined time when operated at no less than a predetermined current density and provided with at least a predetermined electrical energy over the predetermined time. Since these quantities can be determined prior to operation of the hydrogen fueling system including the electrolyzer, these quantities are referred to as predetermined quantities. The predetermined quantity of hydrogen and the predetermined time may be given as specifications for a desired application. For example, refueling passenger cars, or refueling delivery trucks, or refueling warehouse fork lifts, or refueling trains, or refueling airplanes may each have different specifications for a quantity of hydrogen needed within a specified time. In some cases (e.g., in a hydrogen fueling station for passenger cars), it may be desired to refuel a plurality of vehicles (e.g., 2 to 10) simultaneously in a relatively short time (e.g., within 15 minutes). In this case, the predetermined quantity of hydrogen scales with a specified maximum number of vehicles that it is desired for the fueling system to be able to fill simultaneously.

For a given electrolyzer, the current density needed to produce the predetermined quantity of hydrogen in the predetermined time can be determined from an area of a proton-exchange membrane of the electrolyzer. Alternatively, the predetermined current density may be specified, and a membrane area needed to produce the predetermined quantity of hydrogen in the predetermined time may be determined. The electrical energy provided to the electrolyzer can be determined from the known or measured applied cell voltage needed to produce a given current density. In some embodiments, the predetermined quantity of hydrogen is at least 1 kg, or at least 2 kg, or at least 3 kg, or at least 5 kg, or at least 7 kg of hydrogen. In some embodiments, the predetermined time is more than 30 minutes, or no more than 15 minutes, or no more than 12 minutes, or no more than 10 minutes, or no more than 7 minutes, or no more than 5 minutes. In some embodiments, the predetermined current density is at least 5, 6, 7, 8, 9, 10, 12, 14, 16, 18, or 20 A/cm². In some embodiments, at least a predetermined power density (power per unit membrane area) is supplied to the electrolyzer over the predetermined time. In some embodiments, the predetermined power density is at least 10, 12, 14, 16, 18, 20, 25, 30, 35, 40, 50, or 60 W/cm². In some embodiments, the predetermined energy is at least 35, 40, 50, 100, 200, 500, 1000, 2000, 5000, or 10000 kWh.

In some embodiments, in order for the electrolyzer to be able to provide a desired or predetermined quantity of hydrogen within a desired or predetermined time, a large current through the electrolyzer and a corresponding large electrical power is needed. In some cases, an external power connection is not capable of providing the predetermined electrical energy over the predetermined time. For example, an external power connection may be limited to providing a maximum current of 100 A and, in some cases, a current of 100 A through the electrolyzer throughout the predetermined time is not sufficient to produce the predetermined quantity of hydrogen. In some embodiments, the hydrogen filing system includes an electrical energy storage system electrically connected to the electrolyzer. The hydrogen fueling system may then supplied with an external power connection configured to recharge the electrical energy storage system. In some cases, the electrolyzer may be powered by both the electrical energy storage system and the external power connection and may be powered primarily by the electrical energy storage system in at least some operating modes. It is typically preferred that the electrical energy storage system be capable of supplying at least a substantial portion (e.g., at least 20%) of the predetermined electrical energy over the predetermined time (e.g., by producing the electrical energy from chemically, mechanically and/or thermally stored energy). In some embodiments, the electrical energy storage system is capable of supplying, or configured to supply, at least 20%, or at least 40%, or at least 60%, or at least 80%, or at least 100% of the predetermined electrical energy over the predetermined time. In some embodiments, the electrical energy storage system is capable of supplying, or configured to supply, at least 2 times, or at least 3 times, or at least 4 times, or at least 5 times the predetermined electrical energy over the predetermined time. For example, the predetermined electrical energy may be determined by a predetermined quantity of hydrogen corresponding to filling one vehicle, and the electrical energy storage system may be capable of providing enough energy to fill several vehicles.

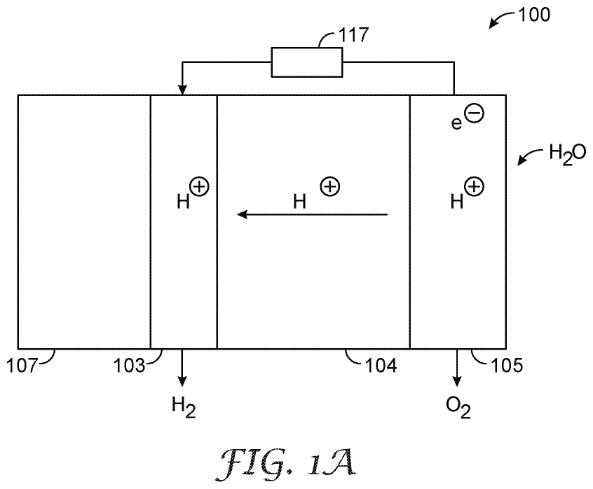

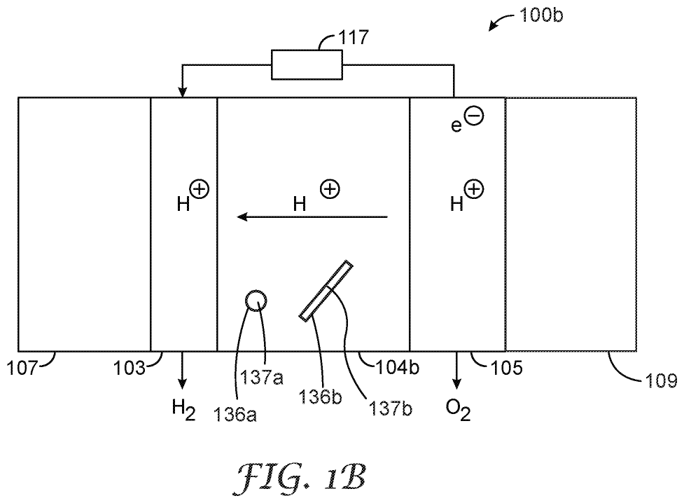

An exemplary electrolyzer including membrane electrode assembly 100 having anode 105 is schematically shown in FIG. 1A. Adjacent anode 105 is proton-exchange membrane 104 having first and second opposed major surfaces. Cathode 103 is situated adjacent proton-exchange membrane 104 on first major surface thereof, while anode 105 is adjacent second major surface of proton-exchange membrane 104. Gas diffusion layer 107, which may alternately be referred to as a fluid transport layer, is situated adjacent cathode 103. Proton-exchange membrane 104 is electrically insulating and permits hydrogen ions (protons) to pass through membrane 104 without allowing product gasses to pass through.

In operation for the electrolysis of water, water is introduced into anode 105 of membrane electrode assembly 100. At anode 105, the water is separated into molecular oxygen (02), hydrogen ions (H⁺), and electrons. The hydrogen ions diffuse through proton-exchange membrane 104 while electrical potential 117 drives electrons to cathode 103. At cathode 103, the hydrogen ions combine with electrons to form hydrogen gas.

The ion conducting membrane forms a durable, non-porous, electronically non-conductive mechanical barrier between the product gases, yet it also passes H+ ions readily. Gas diffusion layers (GDL's) facilitate reactant and product water transport to and from the anode and cathode electrode materials and conduct electrical current. In some embodiments, the anode and cathode electrode layers are applied to GDL's to form catalyst coated backing layers (CCB's) and the resulting CCB's sandwiched with a PEM to form a five-layer MEA. The five layers of a five-layer MEA are, in order: anode GDL, anode electrode layer, PEM, cathode electrode layer, and cathode GDL. In other embodiments, the anode and cathode electrode layers are applied to either side of the PEM, and the resulting catalyst-coated membrane (CCM) is sandwiched between two GDL's to form a five-layer MEA. In operation, the five-layer MEA is positioned between two flow field plates to form an assembly and in some embodiments, more than one assembly is stacked together to form an electrolyzer stack.

In some embodiments, it is desired to operate the electrolyzer of a hydrogen fueling system at higher operating pressure (e.g., 5 MPa, 10 MPa, 15 MPa, 20 MPa, 30 MPa, 40 MPa, 50 MPa, 60 MPa, 70 MPa, 80 MPa, or in a range between any two of these pressures, or at a pressure greater than any of these pressures) than pressures commonly used in water electrolyzers. Higher operating pressures on a water electrolyzer cathode create a situation known as hydrogen crossover, where the hydrogen gas (H₂) crosses from the cathode where it is produced through the PEM, back to the anode. This situation creates both an efficiency loss and, in some situations, an undesired amount of H₂ mixing with the anode gas (O₂) (e.g., exceeds 4 vol. %, which is about the lower explosive limit (LEL)). According to some embodiments of the present description, this hydrogen cross over is significantly reduced by including metallic Pt or Pt oxide in the proton-exchange membrane. An exemplary electrolyzer including membrane electrode assembly 100b including a proton-exchange membrane 104b and an optional second gas diffusion layer 109 is schematically shown in FIG. 1B. In some embodiments, proton-exchange membrane 104b includes at least one of metallic Pt or Pt oxide. In some embodiments, at least a portion of the at least one of metallic Pt or Pt oxide in the proton-exchange membrane 104b is present on a support (e.g., on a least a portion of a surface of the support 137a and/or support 137b). In some embodiments, at least a portion of the at least one of metallic Pt or Pt oxide in the proton-exchange membrane 104b is dispersed in at least a portion of the membrane 104b. In the illustrated embodiment, metallic Pt or Pt oxide 136a and 136b are disposed on supports 137a and 137b, respectively. The support may include a plurality of particles dispersed in the membrane 104b. Only two particles are shown in the schematic illustration of FIG. 1B, but it will be understood that many more particles can be included. In some embodiments, the support includes at least one of carbon, tin oxide, Al₂O₃, TiO₂, ZrO₂, HfO₂, Ta₂O₅, Nb₂O₅, polyimide, and perylene red. In some embodiments, the support includes discrete particles (e.g., 137a, 137b) which may be particles of any of the materials listed above for the support. In some embodiments, the discrete particles include at least one of discrete spheres (e.g., 137a) or discrete elongated particles (e.g., 137b) such as rod-like structures with an aspect ratio of 2:1 to 10:1, for example.

In some embodiments, an electrolyzer includes a membrane 104b having first and second opposed major surfaces and including at least one of metallic Pt or Pt oxide; a cathode on the first major surface of the membrane, the cathode including a first catalyst consisting essentially of at least one of metallic Pt or Pt oxide (i.e., consists essentially of metallic Pt, consists essentially of Pt oxide, or consists essentially of both metallic Pt and Pt oxide); and an anode on the second major surface of the membrane, the anode including a second catalyst, the second catalyst including at least 95 (in some embodiments, at least 96, 97, 98, or even at least 99) percent by weight of collectively metallic Ir and Ir oxide, calculated as elemental Ir, based on the total weight of the second catalyst (understood not to include any support, if any is present), wherein at least one of metallic Ir or Ir oxide is present. A first catalyst consisting essentially of at least one of metallic Pt or Pt oxide has no more than 2% (in some embodiments, no more than 1%) by weight of any other catalyst. In some embodiments, the proton-exchange membrane 104b includes an ion-conductive polymer with a plurality of discrete particles dispersed therein, the particles including a polyimide core and a coating thereon, the coating including at least one of metallic platinum and platinum oxide. In some embodiments, the particles are substantially spherical and have a diameter of less than 10 μm (micrometers). In some embodiments, the coating has an average thickness of less than 25 nm. In some embodiments, the proton-exchange membrane 104b includes a mechanical support such as at least one of a non-woven material, a woven material, and a perforated sheet.

Further details on electrolyzers including a membrane including at least one of metallic Pt or Pt oxide can be found in PCT Appl. No. IB2018/052145 (Lewinski et al.) and in in U.S. Prov. Appl. No. 62/665,001 titled “Platinum-Coated Polyimide Particles and Articles Thereof” and filed on May 1, 2018. Other useful electrolyzers or components for electrolyzers are described in U.S. Pat. Nos. 6,004,494; 5,879,828; 6,136,412; 5,879,827; 6,238,534; and 7,348,088, and in U.S. Pat. Appl. Publ. Nos. 2011/0262828; 2014/0246304; 2015/0311536; and 2017/0294669, and in PCT Publ. No. WO 2016/191057.

In some embodiments, the anode 105 disposed on the membrane 104 or 104b includes a catalyst. The catalyst may be or include iridium. The iridium may be included in the form of metallic iridium and/or in the form of iridium oxide. The catalyst may include Ir deposited onto a whisker coated substrate (Ir-NSTF). The catalyst may be supported on elongated cores in acicular particles as described further elsewhere herein. Such catalysts have been found to provide an increased hydrogen production rate with a smaller quantity of catalyst. In some embodiments, an areal loading of the catalyst is less than 3, 2.5, 2, 1.5, 1.0, 0.75. 0.50, 0.40, 0.30, 0.25, 0.20, 0.15, 0.10, or 0.05 grams per square meter of the anode. The areal loading is the weight of the catalyst per unit area measured along a plane parallel to a major surface of the anode. In some embodiments, the electrolyzer is configured to produce hydrogen at a rate of at least 0.2, 0.45, 0.75, 1.12, 1.49, 1.87, 2.24, 3.73, or 5.6 kilograms of hydrogen per hour per gram of catalyst. In some embodiments, the electrolyzer operates at a current density of at least 5 A/cm², has an anode Ir loading of about 0.25 mg/cm², and produces hydrogen at a rate of at least about 1.87 kg per hour per m² and/or at a rate of at least about 0.75 kg per hour per gram of Ir. In comparison, a traditional electrolyzer may operate at a current density of 1.5 A/cm², may have an anode Ir loading of 3.0 mg/cm², and may produce hydrogen at a rate of 0.56 kg per hour per m² and/or at a rate of 0.02 kg per hour per gram of Ir.

In some embodiments, the cathode 103 disposed on the membrane 104 or 104b includes a catalyst which may include Pt (e.g., Pt deposited onto a whisker coated substrate (Pt-NSTF) or Pt disposed on acicular particles dispersed in an ionomer as described above for Ir) which may be in the form of metallic platinum and/or in the form of platinum oxide.

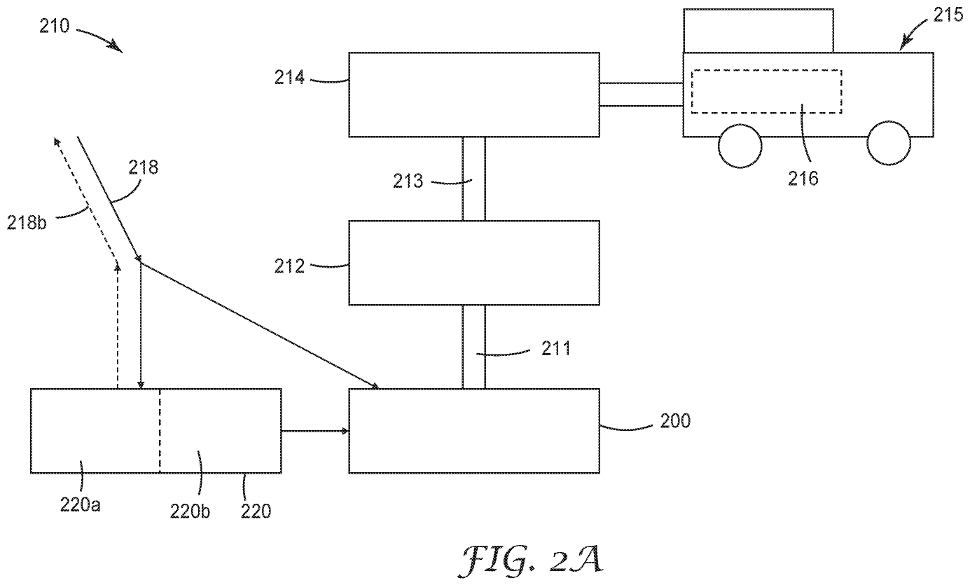

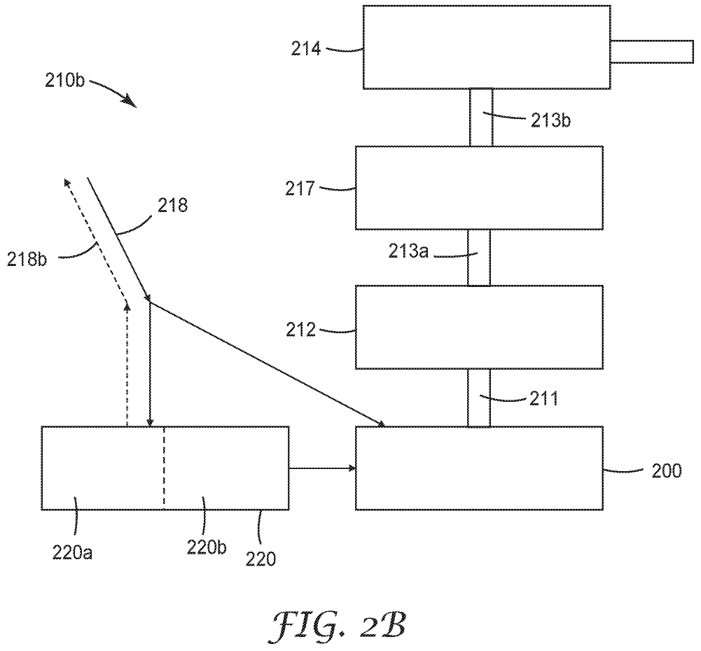

An exemplary hydrogen fueling system 210 for generating hydrogen on demand is schematically illustrated in FIG. 2A. A hydrogen storage system may be described as generating hydrogen on demand when the system substantially increases a rate of hydrogen production (in some embodiments, from zero) when a request is made for hydrogen (e.g., to fill a tank of a vehicle) in at least one operating mode of the system. The system 210 includes an electrolyzer 200, which may correspond to any electrolyzer configured to generate hydrogen described herein; a vehicle tank filling system 214 connected (directly or indirectly) to the electrolyzer 200 and configured to at least partially fill a tank 216 of a vehicle 215 with the compressed hydrogen generated by the electrolyzer 200; and an electrical energy storage system 220 electrically connected to the electrolyzer 200. It will be understood that a vehicle filling system may fill the tank of the vehicle to some desired level (e.g., to some desired pressure) which may or may not be a maximum amount that the tank can hold. The vehicle 215 may be an automobile as schematically illustrated in FIG. 2A. In some embodiments, the vehicle may be at least one of an automobile, a truck, a bus, a train or an aircraft, for example. The system 210 is supplied with an external power connection 218 configured to recharge the electrical energy storage system 220. In some embodiments, the external power connection 218 provides electrical power to both the electrical energy storage system 220 and the electrolyzer 200. The direction of electrical power flow from the external power connection 218 is schematically illustrated by arrows on solid lines from the external power connection 218 for operating modes where the external power connection provides electrical power to the electrical energy storage system. As described further elsewhere herein, in some embodiments, the hydrogen fueling system 210 has an operating mode where the electrical energy storage system provides energy to the external power connection 218; this is schematically illustrated by the arrows on the dotted lines 218b.

In the illustrated embodiment, the vehicle tank filling system 214 is connected indirectly to the electrolyzer 200 through a compression device 212. In other embodiments, the vehicle tank filling system 214 is connected directly to the electrolyzer 200 (e.g., via a pipe with no intervening compression device or storage tank) and the electrolyzer 200 is configured to generate sufficient pressure for supplying hydrogen directly to the vehicle tank filling system 214. In the illustrated embodiment, a compression device 212 is connected to the electrolyzer and configured to compress hydrogen 211 generated by the electrolyzer to form compressed hydrogen 213 and to provide the compressed hydrogen 213 to the vehicle tank filling system 214. The compression device 212 can be any suitable compression device and may include one or more pumps as would be familiar to one of ordinary skill in the art. In some embodiments, the hydrogen 211 generated by the electrolyzer 200 may be at a pressure less than 100 bar (e.g., about 50 bar) and the compression device 212 may be configured to compress the hydrogen to 350 bar or to 700 bar, for example.

In some embodiments, a hydrogen fueling system includes one or more storage tanks. An exemplary hydrogen fueling system 210b for generating hydrogen on demand is schematically illustrated in FIG. 2B. Hydrogen fueling system 210b is similar to hydrogen fueling system 210 but further includes an optional hydrogen storage tank 217 connected to the electrolyzer 200 and to the vehicle tank filing system 214. The hydrogen storage tank 217 may be included so that the hydrogen fueling system 210b can simultaneously provide hydrogen to a larger number of automobiles than otherwise practical during times of peak hydrogen refueling demand, for example. The hydrogen storage tank 217 may also be used as part of the overall energy management of the hydrogen fueling system 210b (e.g., hydrogen can be produced by the electrolyzer 200 and stored in the storage tank 217 at non-peak energy usage times for the power grid) as described further elsewhere herein. In the illustrated embodiment, the hydrogen storage tank 217 is connected indirectly to the electrolyzer 200 through the compression device 212, and the hydrogen storage tank 217 is connected directly to the vehicle filing system 214. In other embodiments, different connections between the various components are utilized. Compressed hydrogen 213a may be provided to the hydrogen storage tank 217 from the compression device 212, and compressed hydrogen 213b may be provided to the vehicle filing system 214 from the hydrogen storage tank 217. The hydrogen storage tank 217 may be smaller than hydrogen storage tanks used in conventional hydrogen fueling systems. For example, the hydrogen storage tank 217 may be configured to hold less than 2000 kg, or less than 1500 kg, or less than 1000 kg, or less than 500 kg, or less than 100 kg of hydrogen. In some embodiments, the hydrogen storage tank 217 is configured to hold at least 10 kg or at least 50 kg of hydrogen, or at least the predetermined quantity of hydrogen, or least 2, 5, or 10 times the predetermined quantity of hydrogen. In some embodiments, the hydrogen storage tank 217 is omitted. In some embodiments, the hydrogen fueling system 210 or 210b is configured to store less than 100 kg, or less than 50 kg, or less than 10 kg, or less than 5 kg of hydrogen, for example. In some embodiments, a hydrogen storage tank is included and the hydrogen fueling system has at least one operating mode in which hydrogen is provided to vehicle(s) primarily from the storage tank and at least one operating mode in which hydrogen is provided to vehicle(s) primarily from hydrogen generated in in real-time (i.e., not previously stored) by the electrolyzer.

The vehicle tank filling system 214 can be any suitable tank filing system for providing hydrogen to a tank of a vehicle. Such vehicle tank filling systems are known in the art. The vehicle 215 schematically illustrated in FIG. 2A may be a passenger vehicle and the hydrogen fueling system 210 may be a configured to provide hydrogen to consumers for passenger vehicles. In other embodiments, the hydrogen fueling system 210 or 210b may be adapted to fill tanks of vehicles used in a warehouse setting (e.g., fork lifts), for example. In some embodiments, the hydrogen fueling system 210 or 210b may be adapted to fill tanks of freight vehicles such as freight trains or semi-locomotive trucks, or of public transportation vehicles such as buses or passenger trains, or of passenger or freight planes. For example, the hydrogen fueling system 210 or 210b may be used by a railroad operator to provide hydrogen to a hydrogen-powered passenger train such as the Alstom Coradia iLint. In another example, the hydrogen fueling system 210 or 210b may be used by an aircraft operator to provide hydrogen to a hydrogen-powered aircraft (fully powered or partially powered by hydrogen).

In some embodiments, the electrolyzer 200 is connected to the compression device 212 with little or substantially no intermediate storage (e.g., a pipe may connect the electrolyzer 200 directly to the compression device 212 with no storage tanks therebetween). In some embodiments, the compression device 212 is connected to the vehicle tank filling system 214 with little or substantially no intermediate storage (e.g., a pipe may connect the compression device 212 to the vehicle tank filling system 214 with no storage tanks therebetween as schematically illustrated in FIG. 2A). In some embodiments, the electrolyzer 200 is connected to the vehicle tank filling system 214 with little or substantially no intermediate storage (e.g., a pipe may connect the electrolyzer 200 directly to the vehicle tank filling system 214 with no storage tanks therebetween). In other embodiments, at least one storage tank is included as illustrated in FIG. 2B. In some embodiments (e.g., in embodiments where there are no intermediate storage tanks), it is desired that the electrolyzer produce a desired quantity of hydrogen within a desired time span and this can, in some cases, result in a need for an electrical energy source in addition to the external power connection 218. The electrical energy storage system 220 may be utilized as this additional electrical energy source.

In some embodiments, the external power connection 218 is provided by an electrical power grid. In some embodiments, the external power connection 218 is replaced by or supplemented with renewable power sources such as solar cells or wind turbines. In some embodiments, the hydrogen fueling system may include the renewable power sources as components of the overall system and may be supplemented with a generator system which may also be considered to be a component of the overall system. In such embodiments, the external power connection can optionally be omitted. In some embodiments, the renewable power sources are used to supplement power provided by the external power connection.

The electrical energy storage system 220 can be any suitable type of electrical energy storage system. In some embodiments, the electrical energy storage system 220 includes at least one of a battery, a flow battery, a redox flow battery, a supercapacitor, a pumped hydro system, a compressed gas system, a thermal storage system, a flywheel, or a non-hydrogen fuel cell. In some embodiments, one or more of these devices are included in the electrical energy storage system 220. In the illustrated embodiment, the electrical energy storage system 220 optionally includes first and second electrical energy storage devices 220a and 220b. Each of the devices 220a and 220b may independently be one or more of a battery, a flow battery, a redox flow battery, a supercapacitor, a pumped hydro system, a compressed gas system, a thermal storage system, a flywheel, or a non-hydrogen fuel cell. Suitable batteries include solid-state batteries, flow batteries, or other electrochemical energy storage devices. Suitable solid-state batteries include lithium ion batteries, nickel-cadmium batteries, and sodium-sulfur batteries. A suitable battery which is a flow battery and a redox flow battery is a vanadium redox flow battery such as those available from UniEnergy Technologies, LLC (Mukilteo, Wash.). Other suitable flow batteries include iron-chromium flow batteries and zinc-bromine flow batteries. Suitable pumped hydro electrical storage systems (or pumped hydroelectric storage systems) include sub-surface pumped hydroelectric, surface reservoir pumped hydroelectric, and variable speed pumped hydroelectric storage systems. Supercapacitors, which may also be referred to as ultracapacitors, are known in the art and include electrostatic double-layer capacitors, electrochemical pseudocapacitors, and hybrid capacitors which stores charge both electrostatically and electrochemically. Suitable flywheels for energy storage include those with composite rotors suspended by magnetic bearings and spinning at speeds of 20,000 rpm, or higher, in a vacuum enclosure. A fuel cell converts chemical energy from a fuel (e.g., hydrogen, methane, natural gas, CO, formic acid, ammonia, hydrazine, borohydrides, or alcohols such as methanol) into electrical energy through an electrochemical reaction of the fuel with oxygen or another oxidizing agent. Since a goal of the hydrogen fueling system is to generate hydrogen, it is typically preferred that the fuel cell use a fuel other than hydrogen (i.e., that the fuel cell be a non-hydrogen fuel cell). A suitable non-hydrogen fuel cell may be one or more of a direct or indirect methanol fuel cell, a proton exchange membrane fuel cell, a phosphoric acid fuel cell, a solid acid fuel cell, a biologic fuel cell, an alkaline fuel cell, a solid oxide fuel cell, and a molten carbonate fuel cell. Suitable compressed gas systems include underground compressed air or compressed carbon dioxide systems. Suitable thermal energy storage systems include those that store thermal energy in molten salts or beds of sand, rocks, concrete, and/or pebbles, for example.

Methods of managing an electrical energy storage system and using the electrical energy storage system with an external power supply are known in the art (see, e.g., U.S. Pat. Appl. Nos. 2013/0154570 (Nomura), 2016/0357165 (Stiefenhofer), 2012/0091802 (Adelson et al.), and 2013/0035802 (Khaitan et al.), 2016/0211678 (Tsurumaru et al.), 2018/0183239 (Shibata et al.), and U.S. Pat. No. 6,441,581 (King et al.), and U.S. Pat. No. 5,701,068 (Baer et al.)). In some embodiments, the hydrogen fueling system includes a power management system (e.g., including at least one of a computer, or a central processing unit, or suitable electric circuitry) adapted to determine how much energy is supplied by the electrical energy storage system and how much energy is supplied by the external power connection. In some embodiments, the power management system places the fueling system into an operating mode that depends on the needed energy, the desired time, the energy or power available from the external power connection, the energy or power available from the electrical energy storage system, the availability of renewable energy, and/or peak load considerations of the external power connection. For example, if the external power connection cannot provide the needed energy in the desired time, the power management system can place the fueling system in a mode where the needed energy is provided at least in part from the electrical energy storage system. In some embodiments, the hydrogen fueling system has an operating mode where the electrolyzer is powered by both the electrical energy storage system and the external power connection. In some embodiments, the hydrogen fueling system has an operating mode where the electrolyzer is powered primarily by the electrical energy storage system (e.g., at least 60%, or at least 80% of the predetermined electrical energy over the predetermined time may be provided by the electrical energy storage system). In some embodiments, the hydrogen fueling system has an operating mode where the electrolyzer is powered primarily by the external power connection. In some embodiments, the hydrogen fueling system has a mode wherein the electrolyzer is inactive and the electrical energy storage system is recharged by the external power connection.

In some embodiments, the electrical energy storage system can store substantially more than (e.g., at least 2, 3, 4, or 5 times) the predetermined energy so that the electrical energy storage system can provide enough energy to power the electrolyzer when it is desired to simultaneously fill several vehicles with hydrogen, for example. In some cases, the electrical energy storage system may have more energy stored than what is expected to be needed in some window of time (e.g., during times of historically low demand for hydrogen refueling or during times when hydrogen is available in storage tank 217). In some cases, this window of time overlaps with peak energy usage of the power grid. The electrical energy storage system may then be adapted to provide electrical power to the external power connection. Storing electrical energy during off peak energy usage times and selling it back to the power grid during peak usage times is known as energy arbitrage or power arbitrage. In some embodiments, the hydrogen fueling system 210, or the electrical energy storage system 220, is adapted for such power arbitrage. In some embodiments, the hydrogen fueling system 210 or 210b has first and second operating modes, where the external power connection 218 recharges the electrical energy storage system in the first operating mode, and the electrical energy storage system 220 provides electrical power to the external power connection in the second operating mode. In some embodiments, the hydrogen fueling system 210 further has a third mode in which the electrical energy storage system 220 provides electrical power to the electrolyzer 200 and not to the external power connection.

In some embodiments, the hydrogen fueling system 210b includes a storage tank 217 and the system 210b is configured to produce hydrogen for storage in the storage tank during times which do not overlap with peak energy usage times for the power grid. This allows the storage tank 217 to be filled or refilled when electrical energy is relatively inexpensive. The system 210 or 210b may also be adapted to recharge the electrical energy storage system 220 during such non-peak energy times. In some embodiments, during peak energy usage times, the electrical energy storage system 220 provides electrical power to the external power connection and hydrogen is provided to the vehicle tank filling system 214 from the storage tank 217. Using the storage tank 217 to provide hydrogen reduces the electrical energy needed by the electrolyzer and allows more energy to be sold to the power grid for energy arbitrage.

In some embodiments, the electrolyzer 200 includes at least one electrode formed from a catalyst-containing dispersion composition including a plurality of acicular particles dispersed within an ionomer binder. Such electrodes (e.g., the anode) have been found to provide an increased hydrogen production rate with a smaller quantity of catalyst and to allow higher current densities to be utilized compared to traditional electrolyzers. The acicular particles are typically not oriented in the electrode composition. As used herein, “not oriented” refers to the acicular particles having a random orientation of their major axes with no observed pattern. These catalyst-containing dispersion compositions may be used in an electrolyzer's anode. Further details on catalyst-containing dispersion compositions including a plurality of acicular particles dispersed within an ionomer binder can be found in U.S. Prov. Appl. No. 62/609,401 filed Dec. 22, 2017 and titled “Dispersed Catalyst-Containing Anode Compositions for Electrolyzers”.

The acicular particles described herein are discrete elongated particles. An acicular particle of the present description includes an elongated core with a layer of catalytic material (e.g., iridium) on at least one portion of a surface of the elongated core. The elongated core is an elongated particle including an organic compound which acts as a support for a catalytic material disposed thereon. Although elongated, the cores of the present description are not necessarily linear in shape and may be bent, curled or curved at the ends of the structures or the structure itself may be bent, curled or curved along its entire length. An elongated particle or elongated core has a length (along the curve of the particle or core in cases where the particle or core is curved) significantly larger (e.g., at least two times) than each lateral dimension orthogonal to the length and typically has an aspect ratio of at least 2:1, 3:1, 5:1, 10:1, 15:1, 20:1, 25:1, or in a range between any two of these aspect ratios. In some embodiments, the elongated core is a microstructured or nanostructured core. The term “discrete” refers to distinct elements, having a separate identity, but does not preclude elements from being in contact with one another.

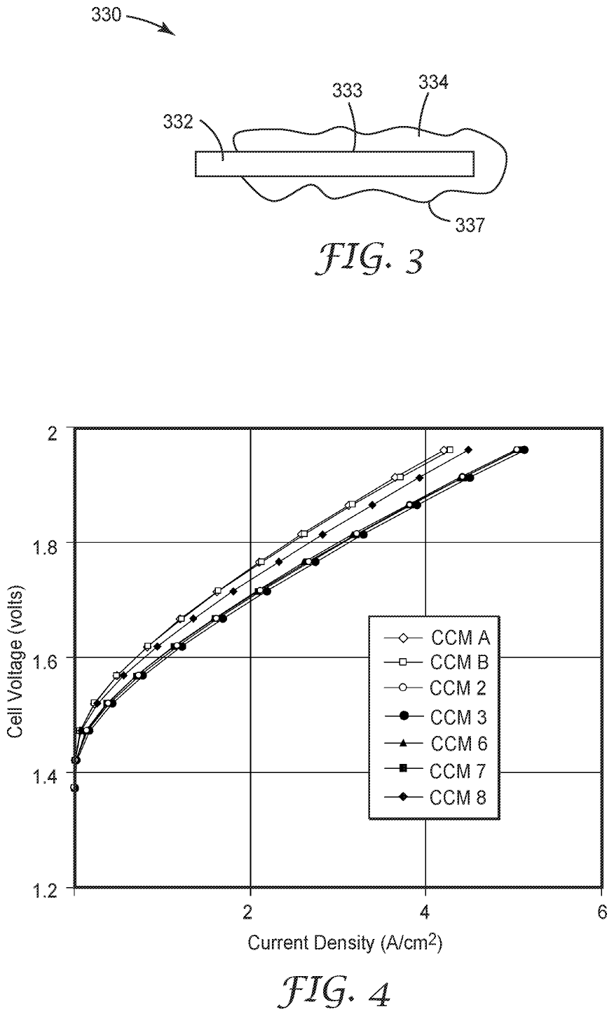

FIG. 3 is a schematic illustration of an acicular particle 330 including an elongated core 332 (which is substantially rod shaped in the illustrated embodiment) and including a layer of catalyst or catalytic material 334 on at least one portion of a surface 333 of the elongated core 332. In some embodiments, an outer surface 337 of the layer of catalyst or catalytic material 334 is nanostructured.

In some embodiments, the elongated core is made from an organic compound. Useful organic compounds include planar molecules including chains or rings over which π-electron density is extensively delocalized. Organic compounds that are suitable for use in the elongated cores generally crystallize in a herringbone configuration. Preferred compounds include those that can be broadly classified as polynuclear aromatic hydrocarbons and heterocyclic compounds. Polynuclear aromatic compounds are described in Morrison and Boyd, Organic Chemistry, Third Edition, Allyn and Bacon, Inc. (Boston: 1974), Chapter 30, and heterocyclic aromatic compounds are described in Morrison and Boyd, supra, Chapter 31. Among the classes of polynuclear aromatic hydrocarbons preferred are naphthalenes, phenanthrenes, perylenes, anthracenes, coronenes, pyrenes, and derivatives of the compounds in the aforementioned classes. A preferred organic compound is commercially available perylene red pigment, N,N′-di(3,5-xylyl)perylene-3,4:9,10 bis(dicarboximide), hereinafter referred to as perylene red. Among the classes of heterocyclic aromatic compounds preferred are phthalocyanines, porphyrins, carbazoles, purines, pterins, and derivatives of the compounds in the aforementioned classes. Representative examples of phthalocyanines especially useful are phthalocyanine and its metal complexes, e.g., copper phthalocyanine. A representative example of porphyrins useful is porphyrin.

Methods for making acicular elements are known in the art. For example, methods for making organic microstructured elements are disclosed in Materials Science and Engineering, A158 (1992), pp. 1-6; J. Vac. Sci. Technol. A, 5, (4), July/August, 1987, pp. 1914-16; J. Vac. Sci. Technol. A, 6, (3), May/August, 1988, pp. 1907-11; Thin Solid Films, 186, 1990, pp. 327-47; J. Mat. Sci., 25, 1990, pp. 5257-68; Rapidly Quenched Metals, Proc. of the Fifth Int. Conf. on Rapidly Quenched Metals, Wurzburg, Germany (Sep. 3-7, 1984), S. Steeb et al., eds., Elsevier Science Publishers B.V., New York, (1985), pp. 1117-24; Photo. Sci. and Eng., 24, (4), July/August, 1980, pp. 211-16; and U.S. Pat. No. 4,568,598 (Bilkadi et al.) and U.S. Pat. No. 4,340,276 (Maffitt et al.). K. Robbie, et al, “Fabrication of Thin Films with Highly Porous Microstructures,” J. Vac. Sci. Tech. A, Vol. 13 No. 3, May/June 1995, pages 1032-35 and K. Robbie et al., “First Thin Film Realization of Bianisotropic Medium,” J. Vac. Sci. Tech. A, Vol. 13, No. 6, November/December 1995, pages 2991-93.

For example, the organic compound may be coated onto a substrate using techniques known in the art including, for example, vacuum vapor deposition (e.g., vacuum evaporation, sublimation, and chemical vapor deposition), and solution coating or dispersion coating (e.g., dip coating, spray coating, spin coating, blade or knife coating, bar coating, roll coating, and pour coating (pouring a liquid onto a surface and allowing the liquid to flow over the surface)). The layer of organic compound is then treated (for example, annealing, plasma etching) such that the layer undergoes a physical change, wherein the layer of organic compound grows to form a microstructured layer including a dense array of discrete, oriented monocrystalline or polycrystalline elongated cores. Following this method, the orientation of the major axis of the elongated cores is usually normal to the substrate surface.

In some embodiments, the organic compound is vapor coated onto a substrate. The substrate can be varied, and is selected to be compatible with the heating process. Exemplary substrates include polyimide and metal foils. The temperature of the substrate during vapor deposition can be varied, depending upon the organic compound selected. For perylene red, a substrate temperature near room temperature (25° C.) is satisfactory. The rate of vacuum vapor deposition can be varied. Thickness of the layer of organic compound deposited can vary and the thickness chosen will determine the major dimension of the resultant microstructures after the annealing step is performed. Layer thicknesses is typically in a range from about 1 nm to about 1 μm, and preferably in a range from about 0.03 μm to about 0.5 μm. The layer of organic compound is then heated for a sufficient temperature and time, optionally under reduced pressure, such that the deposited organic compound undergoes a physical change resulting in the production of a microlayer including pure, single- or poly-crystalline elongated cores. These single- or poly-crystalline structures are used to support a layer of catalytic material, forming the acicular particles of the present description.

In some embodiments, the catalytic material of the acicular particles includes iridium. The iridium may be in a form of iridium metal, iridium oxide, and/or an iridium-containing compound such as IrOₓ, where x may be in the range from 0-2. In some embodiments, the catalytic material further includes ruthenium, which may be in a form of ruthenium metal, ruthenium oxide, and/or may be a ruthenium-containing compound such as iridium oxide, RuOₓ, where x may be in the range from 0-2. The iridium and/or ruthenium includes alloys thereof, and intimate mixtures thereof. In water-based electrolyzer applications, platinum-based anodes tend to be less efficient at oxygen evolution than their iridium counterparts. Thus, the acicular particles are preferably substantially free of platinum (meaning that the composition includes less than 1, 0.5, or even 0.1 atomic % of platinum in the catalytic material) when the acicular particles are used in the anode. In some embodiments, the cathode includes acicular particles having catalytic material thereon that includes platinum.

The iridium and ruthenium may be disposed on the same elongated core or may be disposed on separate elongated cores.

The catalytic material is disposed on at least one surface (more preferably at least two or even three surfaces) of the plurality of elongated cores. The catalytic material is disposed as a continuous layer across the surface such that electrons can continuously move from one portion of the acicular particle to another portion of the acicular particle. The layer of catalytic material on the surface of the organic compound creates a high number of reaction sites for oxygen evolution at the anode.

In some embodiments, the catalytic material is deposited onto the surface of the organic compound initially creating a nanostructured catalyst layer, wherein the layer includes a nanoscopic catalyst particle or a thin catalyst film. In some embodiments, the nanoscopic catalyst particles are particles having at least one dimension equal to or smaller than about 10 nm or having a crystallite size of about 10 nm or less, as measured from diffraction peak half widths of standard 2-tetha x-ray diffraction scans. The catalytic material can be further deposited onto the surface of the organic compound to form a thin film including nanoscopic catalyst particles which may or may not be in contact with each other. A nanoscopic catalyst particle is a particle of catalyst material having at least one dimension of about 10 nm or less or having a crystallite size of about 10 nm or less, measured as diffraction peak half widths in standard 2-theta x-ray diffraction scans.

In some embodiments, the thickness of the layer of catalytic material on the surface of the organic compound can vary, but typically ranges from at least 0.3, 0.5, 1, or even 2 nm; and no more than 5, 10, 20, 40, 60, or even 100 nm on the sides of the elongated cores.

In some embodiments, the catalytic material is applied to the elongated cores by vacuum deposition, sputtering, physical vapor deposition, or chemical vapor deposition.

In some embodiments, the acicular particles of the present disclosure are formed by first growing the elongated cores on a substrate as described above, applying a layer of catalytic material onto the elongated cores, and then removing the catalytically-coated elongated cores from the substrate to form loose acicular particles. Such methods of making elongated cores and/or coating them with catalytic material are disclosed in, for example, U.S. Pat. No. 5,338,430 (Parsonage et al.); U.S. Pat. No. 5,879,827 (Debe et al.); U.S. Pat. No. 5,879,828 (Debe et al.); U.S. Pat. No. 6,040,077 (Debe et al.); and U.S. Pat. No. 6,319,293 (Debe et al.); U.S. Pat. No. 6,136,412 (Spiewak et al.); and U.S. Pat. No. 6,482,763 (Haugen et al.). Such methods of removing the catalytically-coated elongated cores from the substrate are disclosed in, for example, U.S. Pat. Appl. Publ. No. 2011/0262828 (Noda et al.).

Although the plurality of acicular particles can have a variety of shapes, the shape of the individual acicular particles is preferably uniform. Shapes include rods, cones, cylinders, and laths. In some embodiments, the acicular particles have a large aspect ratio, which is defined as the ratio of the length (major dimension) to the diameter or width (minor dimension). In some embodiments, the acicular particles have an average aspect ratio of at least 2, 3, 5, 7, 10, 15, 20 or even 25. In some embodiments, the average aspect ratio is no more than 100, 80, 70, or 60. In some embodiments, the acicular particles have an average length of more than 250, 300, 400, or even 500 nm (nanometer); and less than 750 nm, 1 μm, 1.5 μm, 2 μm or 5 μm. In some embodiments, the acicular particles have an average diameter (or width) of more than 15, 20, or even 30 nm; and less than 100 nm, 500 nm, 750 nm, 1 μm, 1.5 μm, or 2 μm. Such length and diameter (or width) measurements can be obtained by transmission electron microscopy (TEM).

In some embodiments, the size, i.e. length and cross-sectional area, of the acicular particles are generally uniform from particle to particle. As used herein, the term “uniform”, with respect to size, means that the major dimension of the cross-section of the individual acicular particles varies no more than about 23% from the mean value of the major dimension and the minor dimension of the cross-section of the individual acicular particles varies no more than about 28% from the mean value of the minor dimension. The uniformity of the acicular particles provides uniformity in properties, and performance, of articles containing the acicular particles. Such properties include optical, electrical, and magnetic properties. For example, electromagnetic wave absorption, scattering, and trapping are highly dependent upon uniformity of the microlayer.

The ionomer binder is a polymer electrolyte material, which may or may not be the same polymer electrolyte material of the membrane of the electrochemical cell. An ionomer binder is used to aid transport of ions through the electrode. The ionomer binder is a solid polymer, and as such, its presence in the electrode can inhibit transport of reactants to the electrocatalyst. In water electrolyzers, the reactant fluid is liquid water, not a gas. Reactant water transport through the PEM electrolyzer electrode is thought to be much faster than when using gas reactants. Therefore, because the present disclosure is directed toward electrolyzers, it is thought that more ionomer can be used in the electrode composition disclosed herein without reducing high current operation. Having a higher percentage of ionomer in the electrode may be advantageous from a cost perspective and/or enable optimum performance. In some embodiments, the electrode composition includes less than 54, 52, 50, or even 48% by solids volume of the acicular particles versus the total solids volume of the electrode composition (i.e., including the acicular particles and the ionomer binder), and/or alternatively, greater than 46, 48, 50, or even 52% by solids volume of the ionomer versus the total solids volume of the electrode composition.

A useful polymer electrolyte material can include an anionic functional group such as a sulfonate group, a carbonate group, or a phosphonate group bonded to a polymer backbone and combinations and mixtures thereof. In some embodiments, the anionic functional group is preferably a sulfonate group. The polymer electrolyte material can include an imide group, an amide group, or another acidic functional group, along with combinations and mixtures thereof.

An example of a useful polymer electrolyte material is highly fluorinated, typically perfluorinated, fluorocarbon material. Such a fluorocarbon material can be a copolymer of tetrafluoroethylene and one or more types of fluorinated acidic functional co-monomers. Fluorocarbon resin has high chemical stability with respect to halogens, strong acids, and bases, so it can be beneficially used. For example, when high oxidation resistance or acid resistance is desirable, a fluorocarbon resin having a sulfonate group, a carbonate group, or a phosphonate group, and in particular a fluorocarbon resin having a sulfonate group can be beneficially used.

The term “highly fluorinated” refers to a compound wherein at least 75%, 80%, 85%, 90%, 95%, or even 99% of the C—H bonds are replaced by C—F bonds, and the remainder of the C—H bonds are selected from C—H bonds, C—Cl bonds, C—Br bonds, and combinations thereof. The term “perfluorinated” means a group or a compound derived from a hydrocarbon wherein all hydrogen atoms have been replaced by fluorine atoms. A perfluorinated compound may however still contain other atoms than fluorine and carbon atoms, like oxygen atoms, chlorine atoms, bromine atoms and iodine atoms;

Exemplary fluorocarbon resins including a sulfonate group include perfluorosulfonic acid (e.g., Nafion), perfluorosulfonimide-acid (PFIA), sulfonated polyimides, sulfonated polytrifluorostyrene, sulfonated hydrocarbon polymer, polysulfone, and polyethersulfone. Other fluorocarbon resins include perfluoroimides such as perfluoromethyl imide (PFMI), and perfluorobutyl imide (PFBI). In some embodiments, the fluorocarbon resin is a polymer including multiple protogenic groups per sidechain.

Commercially available polymer electrolyte material includes those available, for example, under the trade designation “DYNEON” from 3M Company, St. Paul, Minn.; “NAFION” from DuPont Chemicals, Wilmington, Del.; “FLEMION” from Asahi Glass Co., Ltd., Tokyo, Japan; “ACIPLEX” from Asahi Kasei Chemicals, Tokyo, Japan; as well as those available from ElectroChem, Inc., Woburn, Mass. and Aldrich Chemical Co., Inc., Milwaukee, Wis.).

In some embodiments, the polymer electrolyte material is selected from a perfluoro-X-imide, where X may be, but is not limited to, methyl, butyl, propyl, phenyl, etc.

Typically, the equivalent weight of the ion conductive polymer is at least about 400, 500, 600 or even 700; and not greater than about 825, 900, 1000, 1100, 1200, or even 1500. The equivalent weight (EW) of a polymer is the weight of polymer which will neutralize one equivalent of base.

In some embodiments, the ratio of ionomer binder to the acicular particle is 1:100 to 1:1 by weight, more preferably 1:20 to 1:2 by weight.

In some embodiments, the ratio of ionomer binder to the acicular particle is 1:10 to 10:1 by volume, more preferably 1:3 to 3:1 by volume.

Typically, the plurality of acicular particles is applied along with the ionomer binder, and various solvents in the form of a dispersion, for example, an ink or a paste.

In some embodiments, the plurality of acicular particles and ionomer binder are dispersed in a solvent. Exemplary solvents include water, ketones (such as acetone, tetrahydrofuran, methyl ethyl ketone, and cyclohexanone), alcohols (such as methanol, isopropanol, propanol, ethanol, and propylene glycol butyl ether), polyalcohols (such as glycerin and ethylene glycol); hydrocarbons (such as cyclohexane, heptane, and octane), dimethyl sulfoxide, and fluorinated solvents such as heptadecafluorooctane sulfonic acid and partially fluorinated or perfluorinated alkanes or tertiary amines (such as those available under the trade designations “3M NOVEC ENGINNERED FLUID” or “3M FLUOROINERT ELECTRONIC LIQUID”, available from 3M Co., St. Paul, Minn.

In some embodiments, the catalyst ink composition is an aqueous dispersion, optionally including water and one or more solvents and optionally a surfactant.

In some embodiments, the catalyst ink composition contains 0.1-50%, 5-40%, 10-25%, and more preferably 1-10% by weight of the solvent per weight of the solids (i.e., plurality of acicular particles, and ionomer binder).

In some embodiments, the catalyst composition is applied onto a substrate such as a polymer electrolyte membrane (PEM) or a gas diffusion layer (GDL); or a transfer substrate and subsequently transferred onto a PEM or GDL.

PEMs are known in the art. PEMs may include any suitable polymer electrolyte. The polymer electrolytes typically bear anionic functional groups bound to a common backbone, which are typically sulfonic acid groups, but may also include carboxylic acid groups, imide groups, amide groups, or other acidic functional groups. The polymer electrolytes are typically highly fluorinated and most typically perfluorinated. Exemplary polymer electrolytes include those mentioned for the ionomer binder above. The polymer electrolytes are typically cast as a film (membrane) having a thickness of less than 250 μm, more typically less than 175 μm, more typically less than 125 μm, in some embodiments less than 100 μm, and in some embodiments about 50 μm. The PEM may consist of the polymer electrolyte or the polymer electrolyte may be imbibed into a porous support (such as PTFE). Examples of known PEMs include those available under the trade designations: “NAFION PFSA MEMBRANES” by E.I. du Pont de Nemours and Co., Wilmington, Del.; “GORESELECT MEMBRANE” by W.L. Gore&Associates, Inc., Newark, Del.; and “ACIPLEX” by Asahi Kasei Corp., Tokyo, Japan; and 3M membranes from 3M Co., St. Paul, Minn.

GDLs are also known in the art. In some embodiments, the anode GDL is a sintered metal fiber nonwoven or felt such as those disclosed in CN 203574057 (Meekers et al.), and WO 2016/075005 (Van Haver et al.) coated or impregnated with a metal including at least one of titanium, platinum, gold, iridium, or combinations thereof. The GDLs used can also be powder sintered Ti coated with platinum, gold or combination as the anode or cathode gas diffusion layers. In some embodiments, hydrophobic carbon paper or carbon cloth is used as the cathode gas diffusion layer.

Transfer substrates are a temporary support that is not intended for final use of the electrode and is used during the manufacture or storage to support and/or protect the electrode. The transfer substrate is removed from the electrode article prior to use. The transfer substrate includes a backing often coated with a release coating. The electrode is disposed on the release coating, which allows for easy, clean removal of the electrode from the transfer substrate. Such transfer substrates are known in the art. The backing often is composed of PTFE, polyimide, polyethylene terephthalate, polyethylene naphthalate (PEN), polyester, or similar materials with or without a release agent coating.

Examples of release agents include carbamates, urethanes, silicones, fluorocarbons, fluorosilicones, and combinations thereof. Carbamate release agents generally have long side chains and relatively high softening points. An exemplary carbamate release agent is polyvinyl octadecyl carbamate, available from Anderson Development Co. of Adrian, Mich., under the trade designation “ESCOAT P20”, and from Mayzo Inc. of Norcross, Ga., marketed in various grades as RA-95H, RA-95HS, RA-155 and RA-585S.

Illustrative examples of surface applied (e.g., topical) release agents include polyvinyl carbamates such as disclosed in U.S. Pat. No. 2,532,011 (Dahlquist et al.), reactive silicones, fluorochemical polymers, epoxysilicones such as are disclosed in U.S. Pat. No. 4,313,988 (Bany et al.) and U.S. Pat. No. 4,482,687 (Kessel et al.), polyorganosiloxane-polyurea block copolymers such as are disclosed in U.S. Pat. No. 5,512,650 (Leir et al.), etc.

Silicone release agents generally include an organopolysiloxane polymer including at least two crosslinkable reactive groups, e.g., two ethylenically-unsaturated organic groups. In some embodiments, the silicone polymer includes two terminal crosslinkable groups, e.g., two terminal ethylenically-unsaturated groups. In some embodiments, the silicone polymer includes pendant functional groups, e.g., pendant ethylenically-unsaturated organic groups. In some embodiments, the silicone polymer has a vinyl equivalent weight of no greater than 20,000 grams per equivalent, e.g., no greater than 15,000, or even no greater than 10,000 grams per equivalent. In some embodiments, the silicone polymer has a vinyl equivalent weight of at least 250 grams per equivalent, e.g., at least 500, or even at least 1000 grams per equivalent. In some embodiments, the silicone polymer has a vinyl equivalent weight of 500 to 5000 grams per equivalent, e.g., 750 to 4000 grams per equivalent, or even 1000 to 3000 grams per equivalent.

Commercially available silicone polymers include those available under the trade designations “DMS-V” from Gelest Inc., e.g., DMS-V05, DMS-V21, DMS-V22, DMS-V25, DMS-V31, and DMS-V33. Other commercially available silicone polymers including an average of at least two ethylenically-unsaturated organic groups include “SYL-OFF 2-7170” and “SYL-OFF 7850” (available from Dow Corning Corporation), “VMS-T11” and “SIT7900” (available from Gelest Inc.), “SILMER VIN 70”, “SILMER VIN 100” and “SILMER VIN 200” (available from Siltech Corporation), and 2,4,6,8-tetramethyl-2,4,6,8-tetravinylcyclotetrasiloxane (available from Aldrich).

The release agent may also include a fluorosilicone polymer. Commercially available ethylenically unsaturated fluorosilicone polymers are available from Dow Corning Corp. (Midland, Mich.) under the SYL-OFF series of trade designations including, e.g., “SYL-OFF FOPS-7785” and “SYL-OFF FOPS-7786”. Other ethylenically unsaturated fluorosilicone polymers are commercially available from General Electric Co. (Albany, N.Y.), and Wacker Chemie (Germany). Additional useful ethylenically unsaturated fluorosilicone polymers are described as component (e) at column 5, line 67 through column 7, line 27 of U.S. Pat. No. 5,082,706 (Tangney). Fluorosilicone polymers are particularly useful in forming release coating compositions when combined with a suitable crosslinking agent. One useful crosslinking agent is available under the trade designation “SYL-OFF Q2-7560” from Dow Corning Corp. Other useful crosslinking agents are disclosed in U.S. Pat. No. 5,082,706 (Tangney) and U.S. Pat. No. 5,578,381 (Hamada et al.).

The electrode composition may be initially mixed together in an ink, paste or dispersion. As such, the electrode composition may then be applied to a PEM, GDL, or transfer article in one or multiple layers, with each layer having the same composition or with some layers having differing compositions. Coating techniques as known in the art may be used to coat the electrode composition onto a substrate. Exemplary coating methods include knife coating, bar coating, gravure coating, spray coating, etc.

After coating, the coated substrate is typically dried to at least partially remove the solvent from the electrode composition, leaving an electrode layer on the substrate.

In some embodiments, the composition includes less than 54, 52, 50, or even 48% by solids volume of the acicular particles versus the total solids volume of the composition (i.e., including the acicular particles and the ionomer binder). If there are not enough acicular particles present in the resulting electrode, there will be insufficient electrical conductivity and performance may be reduced. Therefore, in some embodiments, the composition includes at least 1, 5, 10, 20 or even 25% by solids volume of the acicular particles versus the total solids volume of the composition to conduct.

If the coating is applied to the transfer substrate, the electrode is typically transferred to the surface of the PEM. In some embodiments, the coated transfer substrate is pressed against the PEM with heat and pressure, after which the coated transfer substrate is removed and discarded, leaving the electrode bonded to the surface of the PEM.

In some embodiments, the coating is incorporated into an electrolyzer, such as a water electrolyzer as illustrated in FIG. 1A or 1B.

In some embodiments, the anode is formed from the dried electrode composition. In some embodiments, the anode includes less than 54, 52, 50, or 48 percent by volume of the acicular particles. In some embodiments, the anode includes at least 1, 5, 10, 20, or 25 percent by volume of the acicular particles.

In addition to the membrane electrode assembly including the cathode gas diffusion layer, cathode, proton-exchange membrane, anode, and anode gas diffusion layer, the electrolyzer can further include a cathode gasket in contact with the cathode gas diffusion layer.

The membrane electrode assembly is typically installed between a set of flow field plates, which enables the distribution of reactant water to the anode electrode, the removal of product oxygen from the anode and product hydrogen from the cathode, and the application of an electrical voltage and current to the electrodes. The flow field plates are typically non-porous plates including flow channels, have low permeability towards the reactants and products, and are electrically conductive.

The flow field and MEA assembly can be repeated, yielding a stack of repeating units which are typically connected electrically in series.

The cell assembly may also include a set of current collectors and compression hardware.

In the case of a water input, operation of the electrolyzer produces hydrogen and oxygen gases, and consumes water and electrical energy. Application of a voltage across the cell of 1.23V or higher is required to electrochemically produce hydrogen and oxygen from water at standard conditions. As the cell voltage is increased to 1.23V and above, an electronic current commences between the anode and cathode. The electronic current is proportional to the rate of water consumption and the production of hydrogen and oxygen.

The electrolyzers of the present description can have any suitable operational current density consistent with the membrane electrode assembly described herein, for example, an operational current density at 80° C. in a range from 0.001 A/cm² to 20 A/cm², 0.5 A/cm² to 15 A/cm², 1 A/cm² to 10 A/cm², 2 A/cm² to 5 A/cm², or less than, equal to, or greater than 0.001 A/cm², 0.01, 0.1, 0.5, 1, 2, 3, 4, 5, 6, 7, 8, 9, 10, 11, 12, 13, 14, 15, 16, 17, 18, 19, or 20 A/cm² or more. Typically, it is preferred that the operational current density of the electrolyzer used in the hydrogen fueling system be at least 5 A/cm² and/or be at least as high as a predetermined current density described elsewhere herein.

In general, the measured current density is an approximate proportional measure of the absolute catalytic activity of the anode electrode. The relationship between current density and catalytic activity is especially true at low electrode overpotentials. With all other components and operating conditions fixed, higher current densities at a given cell voltage indicated higher absolute catalyst activity. It is generally thought that increasing the catalyst surface area per unit planar area is expected to proportionately increase the absolute catalyst activity, due to increasing the number of active catalytic sites per unit planar area. Methods for increasing the catalyst surface area per unit electrode planar area include (1) increasing the catalyst (e.g., Ir) content of the electrode (e.g., higher Ir areal loadings per unit electrode planar area) and (2) increasing the catalyst (e.g., Ir) surface area per unit catalyst content (e.g., higher specific surface area, m² of Ir electrochemical surface per grams of Ir). Without being bound by theory, the specific surface area (m²/g) would be expected to increase as the Ir metal thin film thickness on the whisker decreases, due to an increasing fraction of the Ir metal being at the thin film surface, rather than within the bulk of the film. Based on the PR 149 whisker geometry, substantially larger absolute incremental area gains would be expected to occur as the Ir thin film thickness on the PR 149 whisker support decreases below about 10 nm.

Traditionally, it is expected that there may be a limitation of a minimum practical catalyst coating thickness on the whisker support, below which the catalyst may be substantially deactivated. Operation of an anode electrode for an electrolyzer requires electronic conduction within the electrode, to enable the electrochemical oxygen evolution reaction. In electrodes including catalyst-coated acicular particles and ionomer and which do not include any other electronic conductor, electronic conduction within the electrode is believed to occur only within the metallic catalyst. As the thickness decreases, the catalyst thin film may not be thermodynamically stable and may instead take the form of individual grains which are not in contact with each other. If the catalyst is in the form of individual grains which are not in contact with each other, some fraction of catalyst material will not be electrochemically active due to lack of electronic conduction, and performance will be lost.

In the present description, it unexpectedly has been found that the use of dispersed acicular particles in the anode of an electrolyzer causes the current density at a particular voltage to increase monotonically as the catalytic material thickness on the elongated core decreases. This enables less catalytic material to be used.

In various embodiments, the present description provides a method of using the electrolyzer. The method can be any suitable method of using any embodiment of the electrolyzer described herein. For example, the method can include applying an electrical potential across the anode and the cathode. In some embodiments, the anode may be used for an oxygen evolution reaction such as in water electrolysis. In some embodiments, in water electrolysis with an acidic membrane electrode assembly, water (e.g., any suitable water, such as deionized water) can be provided to the anode and oxygen gas can be generated at the anode side and hydrogen gas at the cathode side. In some embodiments, in water electrolysis with an alkaline membrane electrode assembly, water can be provided to the cathode side and oxygen gas can be generated at the anode side and hydrogen gas at the cathode side. In some embodiments, the water has a resistivity of about 1 MΩ·cm or higher. In some embodiments, the water has a resistivity of about 18 MΩ·cm.

The present application is related to U.S. Prov. Appl. No. 62/738,100 filed on Sep. 28, 2018, which is hereby incorporated herein by reference in its entirety.

The following is a list of illustrative embodiments of the present description.

A first embodiment is a hydrogen fueling system for generating hydrogen on demand, the hydrogen fueling system comprising:

an electrolyzer configured to generate at least a predetermined quantity of hydrogen in a predetermined time when operated at no less than a predetermined current density and provided with at least a predetermined electrical energy over the predetermined time, the predetermined quantity of hydrogen being at least 1 kg of hydrogen, the predetermined time being no more than 30 minutes, the predetermined current density being at least 5 A/cm²;

a vehicle tank filling system connected to the electrolyzer and configured to at least partially fill a tank of a vehicle with hydrogen generated by the electrolyzer; and

an electrical energy storage system electrically connected to the electrolyzer and capable of supplying at least 20% of the predetermined electrical energy over the predetermined time.

A second embodiment is the hydrogen fueling system of the first embodiment being supplied with an external power connection configured to recharge the electrical energy storage system.

A third embodiment is the hydrogen fueling system of the second embodiment having an operating mode wherein the electrolyzer is powered by both the electrical energy storage system and the external power connection.

A fourth embodiment is the hydrogen fueling system of the second or third embodiments having an operating mode wherein the electrolyzer is powered primarily by the electrical energy storage system.

A fifth embodiment is the hydrogen fueling system of any one of the second to third embodiments, wherein the external power connection is not capable of providing the predetermined electrical energy over the predetermined time.

A sixth embodiment is the hydrogen fueling system of any one of the first to fifth embodiments, wherein at least a predetermined power density is supplied to the electrolyzer over the predetermined time, the predetermined power density being at least 10 W/cm².

A seventh embodiment is the hydrogen fueling system of any one of the first to sixth embodiments, wherein the predetermined electrical energy is at least 35 kWh.

An eight embodiment is the hydrogen fueling system of any one of the first to seventh embodiments, wherein the electrolyzer comprises a membrane having an anode disposed thereon, the anode comprising catalyst, the catalyst comprising iridium, an areal loading of the catalyst being less than 3 grams per square meter of the anode.

A ninth embodiment is the hydrogen fueling system of any one of the first to eight embodiments, wherein the electrolyzer comprises a membrane having an anode disposed thereon, the anode comprising catalyst, the catalyst comprising iridium, and the electrolyzer is configured to produce hydrogen at a rate of at least 0.2 kilograms of hydrogen per hour per gram of catalyst.

A tenth embodiment is the hydrogen fueling system of any one of the first to ninth embodiments, wherein the electrolyzer comprises:

a proton-exchange membrane having first and second opposed major surfaces;
a cathode on the first major surface of the proton-exchange membrane; and an anode on the second major surface of the proton-exchange membrane, wherein the anode comprises (a) an ionomer binder; and (b) a plurality of acicular particles dispersed throughout the ionomer binder, the acicular particles comprising an elongated core with a layer of catalytic material on at least one portion of a surface of the elongated core, the catalytic material comprising iridium.

An eleventh embodiment is the hydrogen fueling system of any one of the first to tenth embodiments, wherein the electrical energy storage system is capable of supplying at least 2 times the predetermined electrical energy over the predetermined time.

A twelfth embodiment is a hydrogen fueling system for generating hydrogen on demand, the hydrogen fueling system comprising:

an electrolyzer configured to generate hydrogen, the electrolyzer comprising:
a proton-exchange membrane having first and second opposed major surfaces;
a cathode on the first major surface of the proton-exchange membrane; and
an anode on the second major surface of the proton-exchange membrane; and

a vehicle tank filling system connected to the electrolyzer and configured to at least partially fill a tank of a vehicle with hydrogen generated by the electrolyzer, wherein the anode comprises (a) an ionomer binder; and (b) a plurality of acicular particles dispersed throughout the ionomer binder, the acicular particles comprising an elongated core with a layer of catalytic material on at least one portion of a surface of the elongated core, the catalytic material comprising iridium, the elongated core comprising at least one of a polynuclear aromatic hydrocarbon, heterocyclic compounds, or combinations thereof.

A thirteen embodiment is the hydrogen fueling system of the twelfth embodiment, wherein the acicular particles are substantially free of platinum.

A fourteenth embodiment is the hydrogen fueling system of the twelfth or thirteenth embodiments, wherein the proton-exchange membrane comprises at least one of metallic Pt or Pt oxide.

A fifteenth embodiment is the hydrogen fueling system of any one of the twelfth to fourteenth embodiments, wherein the anode comprises less than 54 percent by volume of the acicular particles.

In some embodiments, the twelfth embodiment is further characterized according to any one of the first to eleventh embodiments. In some embodiments, any one of the thirteenth to fifteenth embodiments is further characterized according to any one of the first to eleventh embodiments.

### Examples

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Mo., or may be synthesized by conventional methods.

Materials for preparing the Examples include those in Table 1, below.

TABLE 1

| Abbreviation or | |
|---|---|
| Trade Designation | Source |
| “PR 149” | Perylene red pigment (i.e., N,N′-di(3,5- |
| | xylyl)perylene-3,4:9,10-bis(dicarboximide)), |
| | obtained under the trade designation “C.I. |
| | PIGMENT RED 149,” also known as “PR |
| | 149,” from Clariant, Charlotte, NC. |
| “3M825EW | 825 g/mol equivalent weight polymeric |
| MEMBRANE” | perfluorosulfonic acid proton exchange |
| | membrane (PEM), obtained under the trade |
| | designation “3M825EW MEMBRANE” from |
| | 3M Company, St. Paul, MN. |
| “3M725EW | 725 g/mol equivalent weight polymeric |
| POWDER” | perfluorosulfonic acid ion exchange resin, |
| | obtained under the trade designation |
| | “3M725EW POWDER” from 3M Company. |
| “Ir-NSTF” | Iridium/iridium oxide nanostructured thin film |
| | (NSTF) catalyst supported on “PR 149” |
| | whiskers. |
| “KAPTON” | Polyimide film, obtained under the trade |
| | designation “KAPTON” from DuPont, |
| | Wilmington, DE. |
| “MCTS” | Microstructured catalyst transfer substrate, |
| | obtained from 3M Company, St. Paul, MN. |

### Preparation of Electrodes

### Preparing Web of Supported Microstructured Whiskers

Microstructured whiskers were prepared by thermally annealing a layer of perylene red pigment (PR 149) that was sublimation vacuum coated onto microstructured catalyst transfer polymer substrates (MCTS) with a nominal thickness of 220 nm, as described in detail in U.S. Pat. No. 4,812,352 (Debe).

A roll-good web of the MCTS (made on a polyimide film (“KAPTON”)) was used as the substrate on which the PR149 was deposited, as described in detail in U.S. Pat. No. 6,136,412 (Spiewak et al.,). The MCTS substrate surface had V-shaped features with about 3 μm tall peaks, spaced 6 μm apart. A nominally 100 nm thick layer of Cr was then sputter deposited onto the MCTS surface using a DC magnetron planar sputtering target and typical background pressures of Ar and target powers known to those skilled in the art sufficient to deposit the Cr in a single pass of the MCTS web under the target at the desired web speed.

The Cr-coated MCTS web then continued over a sublimation source containing the perylene red pigment (PR 149). The perylene red pigment (PR 149) was heated to a controlled temperature near 500° C. to generate sufficient vapor pressure flux to deposit 0.022 mg/cm², or an approximately 220 nm thick layer of the perylene red pigment (PR 149) in a single pass of the web over the sublimation source. The mass or thickness deposition rate of the sublimation can be measured in any suitable fashion known to those skilled in the art, including optical methods sensitive to film thickness, or quartz crystal oscillator devices sensitive to mass. The perylene red pigment (PR 149) coating was then converted to the whisker phase by thermal annealing, as described in detail in U.S. Pat. No. 5,039,561 (Debe), by passing the perylene red pigment (PR 149) coated web through a vacuum having a temperature distribution sufficient to convert the perylene red pigment (PR 149) as-deposited layer into a layer of oriented crystalline whiskers at the desired web speed, such that the whisker layer has an average whisker areal number density of about 68 whiskers per square μm, determined from scanning electron microscopy (SEM) images, with an average length of about 0.6 μm.

### Preparing Catalyst Coated Nanostructured Thin Films on Supported Microstructured Whiskers

A catalyst coated nanostructured thin film (NSTF) was prepared by sputter coating the catalyst onto the web of supported microstructured whiskers from above using a vacuum sputter deposition system similar to that described in FIG. 4A of U.S. Pat. No. 5,338,430 (Parsonage et al.,) but equipped with additional capability to allow coatings on roll-good substrate webs. The coatings were sputter deposited by using ultra high purity Ar as the sputtering gas at approximately 5 mTorr pressure. Catalyst layers were deposited onto the web of supported nanostructured whiskers by exposing the roll-good substrate in sections to an energized 5 inch×15 inch (13 cm×38 cm) planar sputtering target, resulting in the deposition of the catalyst onto the surface of the entire roll-good substrate. The magnetron sputtering target deposition rate and web speed were controlled to give the desired areal loading of catalyst on the substrate. The DC magnetron sputtering target deposition rate and web speed were measured by standard methods known to those skilled in the art. The substrate was repeatedly exposed to the energized sputtering target, resulting in additional deposition of catalyst onto the substrate, until the desired areal loading was obtained.

### Cathode Preparation

For the cathode preparation, the sputtering target was a pure 5 inch×15 inch (13 cm×38 cm) planar Pt sputter target (obtained from Materion, Clifton, N.J.) resulting in the deposition of Pt onto the web of supported nanostructured whiskers to form Pt-NSTF having 0.25 mg/cm² platinum nanostructured thin film catalyst supported on “PR 149” whiskers.

### Preparatory Samples A-C

For Preparatory Samples A-C, the sputtering target was a 5 inch×15 inch (13 cm×38 cm) planar Ir sputtering target (obtained from Materion, Clifton, N.J.,) resulting in the deposition of Ir onto the web of supported nanostructured whiskers. Table 2 summarizes the characteristics of Preparatory Samples A-C.

For example, for Preparatory Sample A, the Ir areal loading on substrate was 0.75 mg/cm² and the PR 149 areal loading on the substrate was 0.022 mg/cm², yielding an acicular catalyst particle that was 97.2 wt (weight) % Ir. The planar equivalent thickness of 0.75 mg/cm² was calculated to be 332 nm, based on the density of Ir metal, 22.56 g/cm³. Preparatory Sample A was deposited onto the PR 149 whisker support on MCTS described above, which was estimated to have approximately 10 cm² of surface area per cm² planar area, i.e., a roughness factor of about 10. A 332-nm planar equivalent coating onto a substrate with a roughness factor of 10 will have a thickness of approximately 33.2 nm on the PR 149 whisker support, i.e., 1/10^{th} the planar equivalent thickness. The physical thickness of the Ir coating of catalyst-coated-membrane CCM A could be assessed directly by Transmission Electron Microscopy (TEM.) Without being bound by theory, the morphology of a 33.2 nm Ir coating the PR 149 support is expected to be in the form of a Ir metal thin film, consisting of fused Ir metal grains.

### Preparatory Samples D-F

For Preparatory Samples D-F, the sputtering target was a 5 inch×15 inch (13 cm×38 cm) planar Ir sputtering target (obtained from Materion, Clifton, N.J.,) resulting in the deposition of Ir onto the web of supported nanostructured whiskers. Shown in Table 2 is the Ir areal loading on the growth substrate and the PR 149 areal loading on the growth substrate.

TABLE 2

| | | PR 149 | | Ir Planar | |
|---|---|---|---|---|---|
| | Ir Areal | Areal | | Equivalent | Estimated Ir |
| | Loading | Loading | Ir Weight | Thickness | Thickness |
| | on Growth | on Growth | % of | on Growth | on PR 149 |
| | Substrate | Substrate | Catalyst | Substrate | Whisker |
| Sample | (mg/cm²) | (mg/cm²) | Particle | (nm) | (nm) |
| Preparatory Sample A | 0.750 | 0.022 | 97.2 | 332 | 33.2 |
| Preparatory Sample B | 0.500 | 0.022 | 95.8 | 222 | 22.2 |
| Preparatory Sample C | 0.200 | 0.022 | 90.1 | 89 | 8.9 |
| Preparatory Sample D | 0.050 | 0.022 | 69.4 | 22 | 2.2 |
| Preparatory Sample E | 0.100 | 0.022 | 82.0 | 44 | 4.4 |
| Preparatory Sample F | 0.375 | 0.022 | 94.5 | 166 | 16.6 |

### Electrode Ink Formulation A

The Ir-coated PR 149 whiskers from Preparatory Sample D were removed from the MCTS substrate via a manual brushing method, described as follows. Roughly 30 inches of the catalyst on MCTS substrate was unrolled in a hood, catalyst coating side showing face-up. An 1895 Stencil #6 brush (China Stencil) was held, bristles-down, against the film. Using a smooth, dragging motion, the brush was moved across the film, removing whiskers. This brush motion was continued until practically all whiskers were removed from the film, leaving a shiny chrome surface. The removed whiskers, now at one end of the film, were brushed into a 70-mm aluminum dish (VWR). The whiskers were then poured from this dish into a glass bottle for weighing and storage. A new 30 inch (76 cm)-length of NSTF+Ir whisker-coated film was then unrolled and the brushing process was repeated until sufficient quantities of whiskers (1 to 5 grams) were obtained.

2.0 grams of brushed catalyst were then placed into a 125-mL polyethylene bottle (VWR). This bottle was then moved to a nitrogen-only-containing glove bag (VWR) for safely adding additional solvents. After at least 5 minutes in the nitrogen bag, 0.5 grams of water, 12 grams of t-butanol, and 1.5 grams of propylene glycol butyl ether were added to the bottle. This was then briefly shaken before 1.26 grams of 3M725EW ionomer solution (18.8 wt % solids in a solvent 60:40 nPa:water by weight) (725EW ionomer powder is available from 3M company, St. Paul, Minn., USA) was added to the mixture. Finally, 50 grams of 6 mm ZrO₂ media (high density zirconium oxide balls, 5 mm diameter, 6 g/cm³ density, available from Glen Mills Clifton, N.J.) was added to the bottle. This was first shaken for up to 1 minute and then rolled on an automated roller (i.e., ball milled) at between 60 and 180 RPM for 24 hours and the electrode ink is separated from the ZrO₂ media. Electrodes made from this electrode ink, once dried, are calculated to yield an ionomer weight fraction (including Ir, perylene red, ionomer) of 10.6%, which translates to an ionomer solids volume fraction of 51% (comparing ionomer, perylene red and iridium content). The formulation details of Electrode Ink Formulation A are summarized in Table 3.

TABLE 3

| | Elec- | | | | | |
|---|---|---|---|---|---|---|
| | trode | Elec- | Elec- | | | Dry |
| Elec- | Ink | trode | trode | Dry | Dry | Elec- |
| trode | Ionomer | Ink | Ink | Elec- | Elec- | trode |
| Ink | Solids | Catalyst | Solvent | trode | trode | Acicular |
| Formu- | Added | Added | Added | Ionomer | Ionomer | Particle |
| lation | (g) | (g) | (g) | wt % | vol % | vol % |
| A | 0.236 | 2.0 | 65.2 | 10.6 | 51.2 | 48.8 |
| B | 0.205 | 2.0 | 65.2 | 9.3 | 50.9 | 49.1 |
| C | 0.124 | 2.2 | 65.2 | 5.3 | 62.2 | 37.8 |

### Electrode Ink Formulation B

Electrode Ink Formulation B was formulated similarly to Electrode Ink Formulation A, except that the Ir-coated PR 149 whiskers from Preparatory Sample E were used and the electrode ink composition yielded an ionomer weight fraction (including Ir, perylene red, ionomer) of 9.3%, which translates to an ionomer solids volume fraction of 51% (comparing ionomer, perylene red and iridium content, summarized in Table 3.

### Electrode Ink Formulation C

Electrode Ink Formulation C was formulated similarly to Electrode Ink Formulation A, except that the Ir-coated PR 149 whiskers from Preparatory Sample F were used and the electrode ink composition yielded an ionomer weight fraction (including Ir, perylene red, ionomer) of 5.3%, which translates to an ionomer solids volume fraction of 62% (comparing ionomer, perylene red and iridium content), summarized in Table 3.

### Preparation of Catalyst-Coated-Membranes CCMs A-C

A catalyst-coated-membrane (CCM) was made by transferring the catalyst coated whiskers described above onto both surfaces (full CCM) of a 100 μm thick 3M825EW MEMBRANE using the processes as described in detail in U.S. Pat. No. 5,879,827 (Debe et al.). The Cathode Preparation from above (a 0.25 mg/cm² Pt-NSTF catalyst layer) was laminated to one side (intended to become the cathode side) of the PEM, and an Ir-NSTF (one of Preparatory Samples A-C) was laminated to the other (anode) side of the membrane. The catalyst transfer was accomplished by hot roll lamination of the catalysts (on their respective substrates) onto the membrane using a laminator (obtained under the trade designation “HL-101” from ChemInstruments, Inc., West Chester Township, Ohio, USA). The hot roll temperatures were 350° F. (177° C.) and the gas line pressure was fed to force laminator rolls together at the nip at 150 psi (1.03 MPa). The Pt-catalyst and Ir-catalyst coated MCTSs were precut into 15.2 cm×11.4 cm rectangular shape and sandwiched onto two side of a 10.8 cm×10.8 cm portion of 3M825EW PEM. The membrane with catalyst coated MCTS on both sides was placed between 2 mil (51 μm) thick polyimide films and then paper was placed on the outsides, prior to passing the stacked assembly through the nip of the hot roll laminator at a speed of 1.2 ft./min. (37 cm/min.). Immediately after passing through the nip, while the assembly was still warm, the layers of polyimide and paper were quickly removed and the Cr-coated MCTS substrate and the PET substrate were peeled off the CCM by hand, leaving the catalyst coated whiskers stuck to the PEM surfaces. The catalyst coated whiskers stuck to the PEM surfaces form an electrode, consisting of a single layer of oriented whiskers partially embedded into the surface. The areal Ir loading of the anode electrode is listed in Table 4.

TABLE 4

| Catalyst-coated- | | Electrode Ir Areal |
|---|---|---|
| membrane | Anode | Loading (mg/cm²) |
| CCM A | Preparatory Sample A | 0.750 |
| CCM B | Preparatory Sample B | 0.500 |
| CCM C | Preparatory Sample C | 0.200 |
| CCM 1 | Electrode Ink Formulation A | 0.215 |
| CCM 2 | Electrode Ink Formulation A | 0.655 |
| CCM 3 | Electrode Ink Formulation A | 0.669 |
| CCM 4 | Electrode Ink Formulation B | 0.143 |
| CCM 5 | Electrode Ink Formulation B | 0.264 |
| CCM 6 | Electrode Ink Formulation B | 0.737 |
| CCM 7 | Electrode Ink Formulation B | 0.739 |
| CCM 8 | Electrode Ink Formulation C | 0.798 |

### CCM 1

The electrode ink from Electrode Ink Formulation A was coated onto a transfer substrate using a Mayer Rod controlled by an automated Mayer rod coater (obtained under the trade designation “GARDCO AUTOMATIC DRAWDOWN MACHINE”, obtained from Paul N. Garner Co., Pompano Beach, Fla., USA). After coating, the coated substrate was dried in an inerted (nitrogen flowing) oven to at least remove effectively most, if not all, solvent from the electrode composition, leaving a dry electrode layer on the substrate. After drying, the mass of the dry electrode coating and liner were measured, and the known liner mass was subtracted. The areal mass loading of the dry electrode was obtained by dividing the dry electrode mass by the area of the substrate. Using the dry electrode composition information from Table 3, above, and the catalyst composition information from Table 2, the electrode Ir areal loading was calculated to be 0.215 mg/cm², listed in Table 4.

The catalyst-coated membrane CCM 1 was made by laminating the Cathode Preparation from above (a 0.25 mg/cm² Pt-NSTF catalyst layer) to one side (intended to become the cathode side) of the PEM (a 100 μm thick 3M825EW membrane) using the processes as described in detail in U.S. Pat. No. 5,879,827 (Debe et al.). The dispersed Ir-NSTF catalyst layer on transfer substrate was laminated to the other (anode) side of the membrane. The catalyst transfer was accomplished by hot roll lamination of the catalysts (on their respective substrates) onto the membrane using a laminator (obtained under the trade designation “HL-101” from ChemInstruments, Inc., West Chester Township, Ohio, USA). The hot roll temperatures were 350° F. (177° C.) and the gas line pressure was fed to force laminator rolls together at the nip at 150 psi (1.03 MPa). The Pt-catalyst coated MCTS was precut into 15.2 cm×11.4 cm rectangular shape and sandwiched onto one side of a 10.8 cm×10.8 cm portion of PEM. The Electrode Ink Formulation A on liner was precut into 7.5 cm×7.5 cm square shape and sandwiched onto the other side of the 10.8 cm×10.8 cm portion of PEM. The membrane, with the Electrode Ink Formulation A electrode on liner on one side and the cathode catalyst-coated MCTS on the other side, was placed between 2 mil (51 μm) thick polyimide films and then paper was placed on the outside, prior to passing the stacked assembly through the nip of the hot roll laminator at a speed of 1.2 ft./min. (37 cm/min.). Immediately after passing through the nip, while the assembly was still warm, the MCTS substrates and liner layers of polyimide and paper were quickly removed, following by peel-removal of the MCTS substrate and Electrode Ink Formulation A substrate, leaving the electrodes stuck to the PEM surfaces.

### CCMs 2 and 3

CCM 2 and 3 were prepared similarly to CCM 1, except that the coating process for the Electrode Ink Formulation A was varied to yield Ir areal loadings of 0.655 and 0.669 mg/cm² in the dried electrode coatings, respectively, listed in Table 4.

### CCMs 4, 5, 6, and 7

CCM 4, 5, 6, and 7 were prepared similarly to CCM 1, except that the Electrode Ink Formulation B was used instead of the Electrode Ink Formulation A, and the electrode coatings were varied to yield Ir areal loadings for CCMs 4, 5, 6, and 7 of 0.143, 0.264, 0.737, and 0.739 mg/cm², respectively, listed in Table 4.

### CCM 8

The catalyst-coated membrane CCM 8 was prepared similarly to CCM 1, except that the Electrode Ink Formulation C was used instead of Electrode Ink Formulation A to form the electrodes, and the electrode was coated to result in an Ir areal loading was 0.798 mg/cm², listed in Table 4.

### Electrolyzers

The full CCMs fabricated in the above were tested in a water electrolyzer single cell. The full CCM was installed with appropriate gas diffusion layers directly into a 50 cm² single cell test station (obtained under the trade designation “50SCH” from Fuel Cell Technologies, Albuquerque, N. Mex.,) with quad serpentine flow fields. The normal graphite flow field block on the anode side was replaced with a Pt-plated Ti flow field block of the same dimensions and flow field design (obtained from Giner, Inc., Auburndale, Mass.,) in order to withstand the high anode potentials during electrolyzer operation.

The membrane electrode assemblies were formed as follows: 1) a nominally incompressible cathode gasket made from a glass-reinforced polytetrafluoroethylene (PTFE) film (obtained under the trade designation “PTFE COATED FIBERGLASS”, obtained from Nott Company, Arden Hills, Minn., USA), the selected film having a thickness calculated to provide the desired gas diffusion layer compression in the assembled cell; the prepared gasket, having 10 cm×10 cm outside size and 7 cm×7 cm inside hollow, was put on the surface of the graphite flow field block of a 50 cm² Fuel Cell Technologies (Albuquerque, N. Mex.) electrochemical cell (model SCH50, as noted above); 2) a selected cathode porous carbon paper was put in the hollow part of the gasket, with the hydrophobic surface (when present) facing up to contact with the cathode catalyst side of the CCM; 3) the prepared CCM was put on the surface of the carbon paper, with the cathode side with H₂ evolution reaction (HER) catalyst placed in contact with the (hydrophobic) surface of the carbon paper; 4) an anode gasket with 10 cm×10 cm outside size and 7 cm×7 cm inside hollow was placed on the oxygen evolution catalyst-coated surface of the CCM; 5) the anode gas diffusion layer (a nonwoven titanium sheet available under the trade designation “BEKIPOR TITANIUM” from Bekaert Corp, Marietta, Ga., coated with 0.5 mg/cm² of platinum) was placed in the hollow part of the anode gasket with the platinum-plated side facing the anode catalyst (Ir) side of the CCM; 6) the platinized titanium flow field block was placed on the surface of the anode gas diffusion layer and gasket. Then the titanium flow field block, anode gas diffusion layer, CCM, cathode gas diffusion layer, and the graphite flow field block were compressed together with screws. The parts were checked to ensure they could be uniformly assembled and sealed.

Purified water with a resistivity of 18 MΩ·cm was supplied to the anode at 75 mL/min. A power supply (obtained under the trade designation “ESS”, model ESS 12.5-800-2-D-LB-RSTL from TDK-Lambda, Neptune, N.J.) was connected to the cell and was used to control the applied cell voltage or current density. The cell voltage was measured using a voltmeter (obtained under the trade designation “FLUKE”, Model 8845A 6-1/2 DIGIT PRECISION MULTIMETER, from FLUKE Corporation). The cell current was measured by the power supply.

Cell performance was assessed by measurement of a polarization curve, where the cell current density was measured over a range of cell voltages at the temperature at 80° C. and water flow rate of 75 mL/min to the cell anode. Using the power supply, the cell voltage was set to 1.40 V and held for 300 s. During the 300 s hold, the current density and cell voltage were measured at approximately one point per second. This measurement process was repeated at 1.45, 1.50, 1.55, 1.60, 1.65, 1.70, 1.75, 1.80, 1.85, 1.90, 1.95, and 2.00 V, completing the first half of the polarization curve. The second half of the polarization curve consisted of analogous current and voltage measurements at setpoints of 2.00 V, 1.95, 1.90, 1.85, 1.80, 1.75, 1.70, 1.65, 1.60, 1.55, 1.50, 1.45, and 1.40 V.

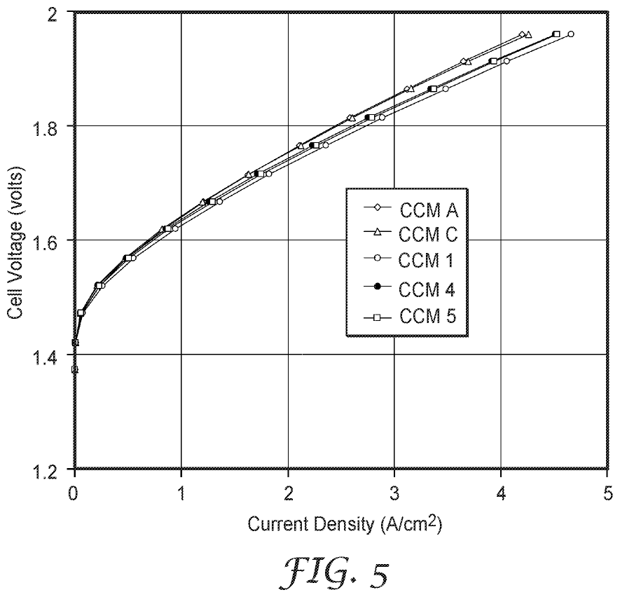

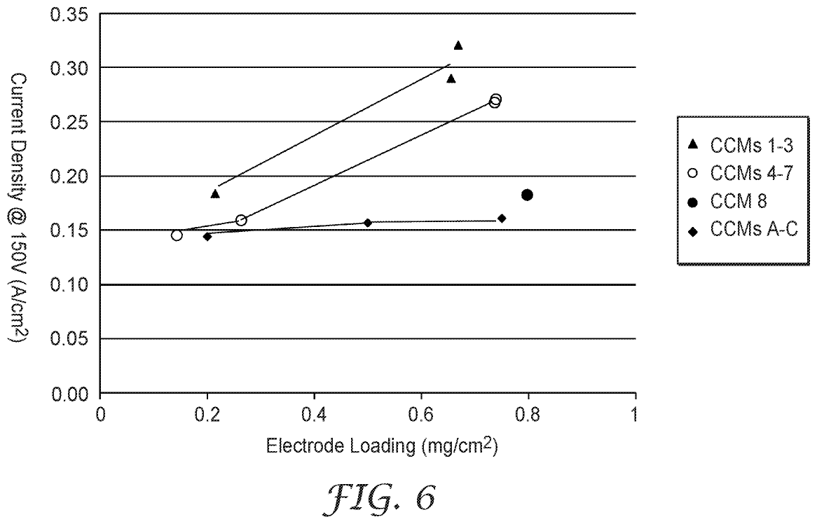

The final polarization curve data was analyzed as follows. First, the measured current densities and cell voltages vs. time from the first half of the polarization curve (the portion increasing from 1.40 V to 2.00 V) were independently averaged over the 300 s at each setpoint, producing an averaged polarization curve. FIGS. 4 and 5 are plots containing the averaged polarization curves of the electrolyzer cells. Next, the current densities at specific cell voltages of 1.45, 1.50, and 1.55 V were obtained by linearly interpolating the averaged polarization curve data. The interpolated current densities are listed in Table 5, below. FIG. 6 is a plot of the interpolated current density at 1.50 V as a function of anode electrode Ir areal loading.

TABLE 5

| Catalyst-coated- | Current Density @ | Current Density @ | Current Density @ |
|---|---|---|---|
| membrane | 1.45 V (A/cm²) | 1.50 V (A/cm²) | 1.55 V (A/cm²) |
| CCM A | 0.039 | 0.161 | 0.389 |
| CCM B | 0.037 | 0.157 | 0.387 |
| CCM C | 0.032 | 0.144 | 0.369 |
| CCM 1 | 0.045 | 0.184 | 0.443 |
| CCM 2 | 0.091 | 0.290 | 0.607 |
| CCM 3 | 0.107 | 0.320 | 0.648 |
| CCM 4 | 0.031 | 0.145 | 0.379 |
| CCM 5 | 0.037 | 0.159 | 0.401 |
| CCM 6 | 0.080 | 0.268 | 0.575 |
| CCM 7 | 0.082 | 0.270 | 0.580 |
| CCM 8 | 0.043 | 0.182 | 0.445 |

### Results

FIG. 6 and Table 5 compare the current density at 1.50 V of various CCMs as a function of anode electrode Ir areal loading. At 1.50 V cell voltage, the measured current density is an approximate proportional measure of the absolute catalytic activity of the anode electrode. Higher current densities at a given cell voltage indicated higher absolute catalyst activity. The anode electrodes of CCMs A, B, and C consisted of a single oriented layer of Ir-coated whiskers embedded into the surface of the membrane, with approximately the same areal number density of whiskers per unit area on the membrane as on the MCTS growth substrate, approximately 68 per square μm. The variation in Ir content in these electrodes was implemented by varying the amount of Ir deposited onto the whiskers, which increased the thickness of the Ir metal thin film on the support whisker. As discussed above, the specific surface area (surface area per unit mass) may decrease as the Ir thin film thickness is increased. For CCMs A and C, the current density increased from 0.032 to 0.039 A/cm², approximately 23%, as the electrode loading increased from 0.20 to 0.75 mg/cm², approximately 275%, coincident with an increase in the Ir metal thickness on support from 8.9 to 33.2 nm.

The anode electrodes of CCMs 1-8 consist of multiple Ir-coated whiskers randomly distributed within an ionomer-containing electrode. The areal number density of Ir-coated whiskers per unit electrode area can be tailored based on the choice of electrode ink fabrication parameters (e.g., whisker-to-ionomer weight ratio, solvent ratio at a given wet coating thickness) and the dried electrode coating thickness. Variation in the areal Ir loading per unit electrode area was accomplished by selecting the electrode coating thickness and the Ir coating thickness on the PR 149 whisker supports. Depending upon the choice of fabrication parameters, the areal number density of whiskers per unit electrode area may range above and below the areal number density of the Ir-coated PR 149 whiskers on the MCTS growth substrate, approximately 68 per square μm.

For CCMs 1 and 3, comprising PR 149 whiskers with a 2.2 nm thick Ir coating, the current density increased from 0.045 to 0.107 A/cm², 134%, as the electrode Ir areal loading increased from 0.215 to 0.669 mg/cm². For CCMs 4 and 7, comprising PR 149 whiskers with a 4.4 nm thick Ir coating, the current density increased from 0.031 to 0.082 A/cm², 161%, as the electrode Ir areal loading increased from 0.143 to 0.739 mg/cm².

CCMs 2, 3, 6, 7, and 8 have Ir areal electrode loadings ranging from 0.655 to 0.798 mg/cm² and comprise PR 149 whiskers with 2.2, 4.4, and 16.6 nm thick Ir coatings. Within this loading range, the current density at 1.50 V increased monotonically from 0.043 to 0.080-0.082 to 0.091-0.107 A/cm² as the Ir thickness on the PR 149 support decreased from 16.6 to 4.4 to 2.2 nm.

Over similar ranges of Ir areal electrode loadings, the increase in absolute current density of CCM 3 over CCM 1, 134%, was higher than the increase in absolute current density of CCM C vs. CCM A, 23%.

Typically, as electrode thickness increases, electrode resistance also increases and at higher current densities, the improvements observed at low current densities are outweighed due to resistive losses that become greater than the low current density improvements. In the present examples, it was unexpectedly found that the improvement in performance of CCMs 1-8 over the CCMs A-C observed at relatively lower current densities and lower cell voltages (e.g. near 1.50V) were also maintained at higher current densities and higher cell voltages (e.g. near 1.90V).

### Hydrogen Fueling Systems

Examples A-C are hydrogen fueling systems including the electrolyzers including the catalyst-coated-membranes CCMs A-C, respectively, and further including a vehicle tank filling system connected to the electrolyzer and configured to at least partially fill a tank of a vehicle with hydrogen generated by the electrolyzer; and an electrical energy storage system electrically connected to the electrolyzer.

Examples 1-8 are hydrogen fueling systems including the electrolyzers including the catalyst-coated-membranes CCMs 1-8, respectively, and further including a vehicle tank filling system connected to the electrolyzer and configured to at least partially fill a tank of a vehicle with hydrogen generated by the electrolyzer. An electrical energy storage system may be electrically connected to the electrolyzer of any one Examples 1-8. A compression device configured to compress hydrogen generated by the electrolyzer to form compressed hydrogen and to provide the compressed hydrogen to the vehicle tank filling system may also be included in any one of Example A-C or 1-8.

The electrolyzers used in the hydrogen fueling systems can be operated at higher cell voltages, and at corresponding higher current densities, than illustrated in FIGS. 4-6.

All references, patents, and patent applications (including provisional, international, and national patent applications) referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof

What is claimed is:

1. A hydrogen fueling system for generating hydrogen on demand, the hydrogen fueling system comprising:
an electrolyzer configured to generate at least a predetermined quantity of hydrogen in a predetermined time when operated at no less than a predetermined current density and provided with at least a predetermined electrical energy over the predetermined time, the predetermined quantity of hydrogen being at least 1 kg of hydrogen, the predetermined time being no more than 30 minutes, the predetermined current density being at least 5 A/cm²;
a vehicle tank filling system connected to the electrolyzer and configured to at least partially fill a tank of a vehicle with hydrogen generated by the electrolyzer; and
an electrical energy storage system electrically connected to the electrolyzer and capable of supplying at least 20% of the predetermined electrical energy over the predetermined time.

2. The hydrogen fueling system of claim 1 being supplied with an external power connection configured to recharge the electrical energy storage system.

3. The hydrogen fueling system of claim 2 having an operating mode wherein the electrolyzer is powered by both the electrical energy storage system and the external power connection.

4. The hydrogen fueling system of claim 3 having an operating mode wherein the electrolyzer is powered primarily by the electrical energy storage system.

5. The hydrogen fueling system of claim 2, wherein the external power connection is not capable of providing the predetermined electrical energy over the predetermined time.

6. The hydrogen fueling system of claim 1, wherein at least a predetermined power density is supplied to the electrolyzer over the predetermined time, the predetermined power density being at least 10 W/cm².

7. The hydrogen fueling system of claim 1, wherein the predetermined electrical energy is at least 35 kWh.

8. The hydrogen fueling system of claim 1, wherein the electrolyzer comprises a membrane having an anode disposed thereon, the anode comprising catalyst, the catalyst comprising iridium, an areal loading of the catalyst being less than 3 grams per square meter of the anode.

9. The hydrogen fueling system of claim 1, wherein the electrolyzer comprises a membrane having an anode disposed thereon, the anode comprising catalyst, the catalyst comprising iridium, and the electrolyzer is configured to produce hydrogen at a rate of at least 0.2 kilograms of hydrogen per hour per gram of catalyst.

10. The hydrogen fueling system of claim 1, wherein the electrolyzer comprises:
a proton-exchange membrane having first and second opposed major surfaces;
a cathode on the first major surface of the proton-exchange membrane; and
an anode on the second major surface of the proton-exchange membrane, wherein the anode comprises (a) an ionomer binder; and (b) a plurality of acicular particles dispersed throughout the ionomer binder, the acicular particles comprising an elongated core with a layer of catalytic material on at least one portion of a surface of the elongated core, the catalytic material comprising iridium.

11. The hydrogen fueling system of claim 1, wherein the electrical energy storage system is capable of supplying at least 2 times the predetermined electrical energy over the predetermined time.

12. A hydrogen fueling system for generating hydrogen on demand, the hydrogen fueling system comprising:
an electrolyzer configured to generate hydrogen, the electrolyzer comprising:
a proton-exchange membrane having first and second opposed major surfaces;
a cathode on the first major surface of the proton-exchange membrane; and
an anode on the second major surface of the proton-exchange membrane; and
a vehicle tank filling system connected to the electrolyzer and configured to at least partially fill a tank of a vehicle with hydrogen generated by the electrolyzer,
wherein the anode comprises (a) an ionomer binder; and (b) a plurality of acicular particles dispersed throughout the ionomer binder, the acicular particles comprising an elongated core with a layer of catalytic material on at least one portion of a surface of the elongated core, the catalytic material comprising iridium, the elongated core comprising at least one of a polynuclear aromatic hydrocarbon, heterocyclic compounds, or combinations thereof.

13. The hydrogen fueling system of claim 12, wherein the acicular particles are substantially free of platinum.

14. The hydrogen fueling system of claim 12, wherein the proton-exchange membrane comprises at least one of metallic Pt or Pt oxide.

15. The hydrogen fueling system of claim 12, wherein the anode comprises less than 54 percent by volume of the acicular particles.
